(19) United States
(12) Patent Application Publication
(10) Pub. No.: US 2012/0251985 A1
(43) Pub. Date: Oct. 4, 2012

(54) LANGUAGE-TUTORING MACHINE AND METHOD

(75) Inventors: Luc Steels, Paris (FR); Remi Van Trijp, Paris (FR)

(73) Assignee: SONY CORPORATION, Tokyo (JP)

(21) Appl. No.: 13/499,768

(22) PCT Filed: Oct. 8, 2010
(86) PCT No.: PCT/EP10/65108

§ 371 Date: Jun. 11, 2012

(30) Foreign Application Priority Data
Oct. 8, 2009 (EP) 09305959.0

(51) Int. Cl. G09B 19/00

(52) U.S. Cl. 434/156

(57) ABSTRACT

A language tutoring machine communicates with a user for teaching of a linguistic sub-system in a particular language. The language tutoring system comprises at least one computational module that functions to produce and comprehend utterances which employ the linguistic sub-system. The at least one computational module embodies two models which operationalizes the linguistic sub-system; a student model approximating a specified user's performance when producing and comprehending language involving the linguistic sub-system, and a teacher model which represents an archetypal configuration of the language-system. The teacher model and student model use the same formalisms, advantageously Incremental Recruitment Language (for conceptualising and interpreting) and Fluid Construction Grammar (for expression and parsing). This enables a single computational module to be operated, at different moments, to represent the teacher model and to represent the student model, and enables the same components to be used for language production and comprehension.

### BACKGROUND OF THE INVENTION

1. Field of the Invention

The present invention relates to a language tutor machine and method, configured to assist a user to learn a language, notably a human language.

2. Background of the Invention

In human languages (“natural languages”), every utterance combines a set of lexical and grammatical features that deal with different aspects of meaning and function. For example, the sentence “Sophie walked home” introduces a number of entities (Sophie, home), an event (walk), its participant roles (agent, target), and the time of the event (past). In the field of linguistics, it is common to identify, within a language, a number of different sub-systems that are used instinctively by native speakers of the language when speaking or listening to utterances which exhibit features that centre around the same meaning or function. Examples of these kinds of sub-system include the tense system in English, the case grammar of Latin, the reflexive and reciprocal pronoun system of Spanish, the classifier system of Swahili, and so on.

Many of such sub-systems are based on a particular way of categorizing and conceptualizing reality, which may differ significantly from one language to another. For example, the Japanese language has no equivalent to the system of articles (definite article/indefinite article, mass noun/count noun) that is used in languages such as English and French in order to be more precise about the referent of a noun. As another example, Dutch and other Germanic languages use body postures such as “sit”, “stand” and “lie” in metaphorical senses to describe the position of objects (as in “the bottle stands on the table”), and these metaphorical uses can be extended to describe the behaviour of abstract objects, for example “the economy sits in a recession”.

It can be particularly difficult for a student of a foreign language to learn a sub-system that is based on a categorization and conceptualization of reality. In order to acquire the applicable semantics, the student must a) learn the categorization of reality that is implied by this sub-system, b) acquire the associative extensions of these semantic categories (i.e. how these semantic categories can be extended, by association of ideas, for usage in a non-literal fashion), and c) learn the analogical usage of a semantic system from one domain (e.g. space) to another domain (e.g. time) so that the student can make up utterances which conform to the linguistic sub-system but which he has not heard before.

Various computer-assisted techniques have been proposed in the past for helping a user to acquire proficiency in a target language. The programmed computers used in such techniques are often referred to as computer-assisted language learning systems (C.A.L.L. systems or machines) although this expression can lead to confusion given that the machine itself is engaged in language teaching. The known C.A.L.L. machines tend to be of two main types (or hybrids of the two), notably:
machines based on programmed teaching (so-called “programmed instruction” machines) where the student interacts with the computer according to a pre-programmed script which may allow for some limited, and predefined, variations, or
machines which provide more open-ended learning environments, where the student is presented, in a flexible manner, with different possible learning contexts; some such machines provide almost totally open environments (e.g. the contents of the worldwide web) with a small degree of personalization achieved by identification of resources that should be relevant to the student, but it is more helpful to provide machines where learning is personalized to the student's state of knowledge and the machine is able to interpret why the student reacts in a particular way.

Commercial assisted-language-learning products on the market tend to be programmed-instruction-type computer programs. These are not particularly congenial for the learner to use because of their inflexibility. For example, if the student re-runs a particular lesson, he is liable to be presented with the same materials/dialogue as he encountered on previous occasions. Open-ended learning environments have been much discussed, but (to our knowledge) no actual products providing personalized, open-ended learning environments have been commercialized.

It is a challenge to design a C.A.L.L. machine that provides a language student with an open-ended and personalized learning environment, that is, an environment in which the system will present the student with learning situations (“contexts”) which are appropriate to his state of linguistic competence/knowledge at that time and which stimulate the learner to actively use and extend his language knowledge. One approach that has been proposed is to decompose the task of learning a specified language into the sub-tasks of learning the various linguistic sub-systems that are in that language.

According to this subtask-based approach, learning of a given language can be assisted by a machine (typically a computer) which provides an operational learning environment which focuses at a given time on the learning of a selected linguistic sub-system (e.g. colour terms, tense and aspect, relative clauses, determiners, and so on). The computer presents the human user with a context (typically using visual means, such as pictures or video clips), sets up a framework task (e.g. selection of a picture, answering a question) which, for proper completion, entails successful communication between the computer and user relating to the context and using the selected linguistic sub-system, presents a sentence to the user in order to elicit a reaction that contributes to completion of the framework task (the reaction could be some choice made by the student, or the user's inputting of a sentence), and provides feedback on whether there has been communicative success or failure. The feedback may include correction. According to this technique, the learner is stimulated to actively use his language knowledge in the process of communicating with the computer, and he receives a corrected answer.

A machine implementing this technique includes:
a) an internal representation of the linguistic sub-system to be taught (designated a teacher model), and this representation is operational, that is, it can be operated to produce and comprehend utterances, in context, which conform to the selected linguistic sub-system;
b) an operational internal representation of the selected linguistic sub-system as currently employed by the student (designated a “student model”); and
c) a teaching strategy which decides which situations/contexts are going to be presented to the student with the aim of increasing his competence in use of the selected linguistic sub-system.

According to the above-described proposal, the teacher model, the student model and the language strategy would all be implemented as computational systems. The student model is helpful because it can serve to decode student input in cases where the student is using the linguistic sub-system inaccurately. The teaching strategy consists in referring to the teacher model so as to work out where the student model is deficient at a given time, so as to determine which aspects of the linguistic sub-system are not yet known by the student at that time, and presenting the student—in an adaptive manner—with learning situations/contexts that relate to the aspects of the linguistic sub-system that the student needs to learn next.

The above-described approach is considered to be promising, but it is not widely used because of the following technical problems:
if it is desired to use this approach to help users to learn substantially any natural language then it would be necessary for the system designer to build a respective teacher model for all of the linguistic sub-systems that exist in all of the languages of the world: this would be difficult and extremely time-consuming;
some technique must be found for generating a student model which accurately represents the student's current competence in relation to the linguistic sub-system that he is studying at a particular time, and
some mechanism is required to ensure that the student is motivated to continue learning, as students report being bored when teaching is based purely on a comparative teaching strategy (the problem of maintaining student-motivation affects C.A.L.L. systems in general).

A lot of work has been done relating to the question of how to develop an appropriate student model for use in the above approach, so that it can accurately represent the student's competence in relation to a linguistic sub-system and can be dynamically updated as the student's competence increases. One prior proposal involves, in a preliminary stage, making the student go through a programmed-instruction-based series of interactions with a C.A.L.L. machine. The student model is then developed by interpretation of the student's input during this preliminary phase. However, a prescriptive preliminary phase of this kind is liable to be boring for the user to undertake. Moreover, it is not clear how the initial student model developed during this preliminary phase should be updated as the student's competence increases.

Indeed, one of the main difficulties there has been in implementing language tutoring systems which make use of teacher and student models is the need to be able to update the student model, dynamically, in a manner that closely matches with the student's increasing competence. This difficulty arises, at least in part, because of the nature of language acquisition in humans.

When a human learner seeks to acquire linguistic competence he (consciously or unconsciously) implements a language-acquisition strategy; this strategy not only helps with acquiring the purely phonetic, syntactic or lexical aspects of a linguistic sub-system, but also with meaning: How should the concepts be acquired that are needed in this language system? How should the ontology be expanded when no adequate meanings can be found to achieve the desired communicative goals? And it incorporates procedures to deal with pragmatic issues: How should meanings be interpreted and acted upon, what kind of interaction could repair a failed interaction? How can additional questions help to fix misunderstandings or generate data for learning?

To achieve its purpose, a language strategy encompasses three kinds of functions. Firstly, it contains a learning function, which the hearer exercises to acquire the linguistic aspects of a language system as well as the conceptualizations employed by it. The learning function typically includes ways to extract enough information from contextualized utterances to reconstruct the conceptual and linguistic structures that are used by the speaker but unknown to the hearer. Secondly, a language strategy covers not only how to learn the system in place at a particular moment in time, but also how a speaker may flexibly adapt and expand his own conception of the linguistic sub-system in order to deal with novel cases, without losing the systematicity present in the linguistic sub-system.

Thirdly, a language strategy includes an alignment function by which speakers and hearers coordinate their linguistic systems, primarily by adjusting the scores of the linguistic items in their inventory. This is necessary to handle the unavoidable variation that occurs in language use. Two speakers of the same language usually do not use exactly the same constructions or conceptualizations. One speaker may use the present perfect tense in a sentence such as “I have just written her a letter”, whereas another speaker may prefer to use a simple past tense in the same circumstances, as in “I just wrote her a letter.” One speaker may treat the word “agree” as a transitive verb, combinable with a direct object, as in “I ask you to formally agree this arrangement”, whereas another speaker may prefer to treat the word “agree” as an intransitive verb so that the object of agreement must be introduced with a preposition, as in “I ask you to formally agree with this arrangement”. Nevertheless, language coherence is sufficiently high so that even speakers who have never met each other have a reasonably high chance of communicative success. Presumably, this is because speakers and hearers have ways to align their linguistic choices not only on a global scale (to bring their own language-system closer to that of the community) but also as part of situated language interactions.

### BRIEF SUMMARY OF THE INVENTION

The present inventors have postulated a new approach for automated assistance in language learning. This new approach has developed from the notion that linguistic sub-systems can be “operationalized”, that is, they can be considered in terms of the set of knowledge sources and procedures that are needed in order to be able to produce and comprehend utterances which exhibit the features of the linguistic sub-system. This set of knowledge sources and procedures can then be considered to define a “language-system” and a working model of the “language-system” can be built, using functional units and data sources. When appropriate data is loaded in the data sources, the working model of a language-system can be operated to generate utterances which conform to the linguistic sub-system in question and/or to comprehend such utterances.

A linguistic sub-system that is to be taught can be analysed in operational (functional) terms so as to determine what language-system (i.e. knowledge sources, procedures, etc.) is needed in order to produce utterances and/or comprehend utterances that conform to this linguistic sub-system. A teacher model can then be provided which corresponds to a target configuration of this language-system (i.e. a configuration which exhibits a desired level of linguistic competence when producing and/or comprehending utterances which conform to the linguistic sub-system). In a similar way, a student model can be provided which also corresponds to a configuration of this same language-system. According to the new approach provided by the present invention, the same architecture is used for the language-system in the student model and the language-system in the teacher model.

The present invention provides a language tutoring machine according to claim 1 annexed hereto.

The present invention further provides a computer program according to claim 10 annexed hereto, having a set of instructions which, when in use on computer apparatus, cause the computer apparatus to perform the steps of language tutoring method.

In preferred embodiments of the present invention the student model language-system and the teacher model language-system both make use of the language-processing framework provided by Fluid Construction Grammar for converting between a given semantic structure and a particular form expressing that semantic structure. Fluid Construction Grammar is a true bidirectional formalism not just because it uses the same inventory of concepts, words and grammatical constructions for parsing and for expression but also because it uses the same processing engine to implement the parsing and expression processes. Embodiments which use Fluid Construction Grammar (FCG) for language processing in the teacher model and student model language-systems have the advantage that they can use the same components for determining how to express utterances and for parsing utterances. Moreover, the same component can implement FCG processing for the teacher model language-system and for the student model language-system.

In preferred embodiments of the present invention which use FCG the language-system in the student model makes use of adaptation and consolidation procedures built into Fluid Construction Grammar which enable existing constructions (and their constituent categories, functions, etc.) to be developed and new constructions (categories, etc.) to be created. Accordingly, the student model can be developed in a dynamic manner, based on the interactions between the language tutoring machine and the user.

In preferred embodiments of the present invention the language-system in the teacher model makes use of adaptation and consolidation procedures built into Fluid Construction Grammar which enable existing constructions (categories, functions, etc.) to be developed and new constructions (categories, etc.) to be created. In this way the teacher model can be learned, through interactions between the language tutoring machine (acting as a student) and a person adept in the relevant language, instead of requiring explicit programming.

In certain preferred embodiments of the present invention the student model language-system and the teacher model language-system both make use of the conceptualisation framework provided by Incremental Recruitment Language (IRL), which represents the meanings of utterances as constraint networks (rather like programs to be solved by the hearer), whose nodes correspond to cognitive operations that are involved in determining the meaning of the relevant utterance. An advantage of using IRL for conceptualization is that IRL both enables the truth-value of an utterance to be conceptualized and also permits different conceptualizations to be made depending on the speaker's communicative goal. For example, the utterances “I have just written a letter” and “I wrote a letter” have the same truth-value but in the first instance the speaker seeks to emphasize the fact that the event was very recent and still relevant at the time of speaking, whereas in the second instance the speaker emphasizes the fact that the event is in the past (i.e. it has been completed). By using cognitive operations, IRL models the meanings of utterances in terms of the physical and mental actions or operations that the hearer has to perform in order to comprehend the utterance and so can adopt a conceptualization which reflects the speaker's communicative goal as well as the truth-value of the utterance in question.

Another advantage of using IRL for conceptualization in the language tutoring machines of the invention, which involve processing of utterances which occur during interactions that are grounded in some shared context, is that IRL provides a uniform formalism applicable for different grounding techniques (i.e. it can handle visual, auditory and sensori-motor perceptions and actions). Accordingly, embodiments which make use of IRL for conceptualization and interpretation can cope with dynamic, open-ended communicative situations.

Similarly to Fluid Construction Grammar, Incremental Recruitment Language is a bidirectional formalism. In the case of IRL, the same inventory is used for conceptualization and for interpretation, and the same processing engine is used to implement the conceptualization and interpretation functions. Accordingly, embodiments which use Incremental Recruitment Language for conceptualisation of the meaning of an utterance provide the advantage that they can use the same components for conceptualization and for interpretation of an utterance. Moreover, the same component can implement IRL processing for the teacher model language-system and for the student model language-system.

In preferred embodiments of the present invention which use IRL, the language-system in the teacher model and/or the student model may make use of adaptation procedures built into IRL which enable new prototypes, categories, relations and concepts to be created for use by the cognitive operations and which allow successful networks of cognitive primitives to be stored as “chunks”. In this way the teacher model and/or student model can be learned/developed though interactions between the language tutoring machine and the user.

It is advantageous for embodiments of the invention to make use both of IRL for conceptualization and interpretation and of FCG for expression and parsing. This enables fully bidirectional processing using the same components for production and understanding of utterances. During “speaking”, a language tutoring machine according to such embodiments first conceptualizes a meaning using IRL and then verbalizes the semantic structure using FCG. When “listening”, a language tutoring machine according to such embodiments parses a form into a meaning using FCG and this meaning is then interpreted using IRL.

In certain preferred embodiments of the present invention the language tutoring machine is adapted to make an active choice between different teaching strategies that could be employed when interacting with a user. Rules defining the different teaching strategies are stored or accessed by the language tutoring machine, as required. The choice of appropriate teaching strategy can be dependent on features of the student's learning. An autotelic mechanism may be included in the applied teaching strategy in order to regulate the complexity of the learning environment, maintaining the student's interest.

### BRIEF DESCRIPTION OF THE SEVERAL VIEWS OF THE DRAWINGS

Features and advantages of the present invention will become clearer from the following description of preferred embodiments thereof, given by way of example and not limitation, with reference to the appended drawings, in which:

FIG. 1 is a block diagram which illustrates, schematically, components of a first embodiment of language tutoring machine according to the present invention;

FIG. 2 shows block diagrams indicating main modules which make up one form of representation of a language-system used in certain embodiments of the invention, in which:

FIG. 2A represents one configuration of the modules that may be used, and

FIG. 2B represents a module configuration used in preferred embodiments of the invention;

FIG. 3 is a flow diagram indicating steps in a communicative interaction between a tutoring tool of a language tutoring machine according to a first embodiment of the invention and a user;

FIG. 4 is a flow diagram indicating steps in a communicative interaction where the tutoring tool helps a user to practice comprehension of a language;

FIG. 5 is a flow diagram indicating steps in a communicative interaction where the tutoring tool helps a user to practice production of a language;

FIG. 6 is a flow diagram indicating steps in a communicative interaction where a human user acts as a tutor for developing the language-comprehension modules of a tutoring tool;

FIG. 7 is a flow diagram indicating steps in a communicative interaction where a human user acts as a tutor for developing the language-production modules of a tutoring tool;

FIG. 8 is a schematic diagram illustrating modules and processes used by a colour-term tutoring tool when engaging in interactions according to a first scenario.

FIG. 9 illustrates screen views that were displayed during two example interactions according to the first scenario, involving the colour-term tutoring tool, in which:

FIG. 9A corresponds to an interaction which involved communicative success, and

FIG. 9B corresponds to an interaction which involved communicative failure, and

FIG. 10 is a schematic diagram illustrating modules and processes used by the colour-term tutoring tool when engaging in interactions according to a second scenario.

FIG. 11 illustrates screen views that were displayed during one example interaction according to the first scenario, involving the colour-term tutoring tool, in which:

FIGS. 11A, 11B and 11C are views of successive screen displays observed during the interaction;

FIG. 12 is a diagram which illustrates, schematically, the main modules and processes that were used by the colour term tutoring module when engaging in interactions according to a fourth scenario;

FIG. 13 illustrates screen views that were displayed during one example of a successful interaction according to the fourth scenario, involving the colour-term tutoring tool, in which:

FIGS. 13A and 13B are views of successive screen displays observed during the interaction;

FIG. 14 provides an example of a screen display which presents a selected context (video clip) to the user in a French-tense tutoring tool;

FIG. 15 is a schematic diagram illustrating main modules and processes used by a French-tense tutoring tool when implementing interactions according to the first scenario;

FIG. 16 illustrates screen views that were displayed during two example interactions according to the first scenario and involving the French-tense tutoring tool, in which:

FIG. 16A corresponds to an interaction which involved communicative success, and

FIG. 16B corresponds to an interaction which involved communicative failure;

FIG. 17 is a schematic diagram illustrating main modules and processes used by the French tense tutoring tool when implementing interactions according to the second scenario;

FIG. 18 illustrates screen views that were displayed during one example of a successful interaction according to the second scenario and involving the French-tense tutoring tool, in which:

FIGS. 18A and 18B are views of successive screen displays observed during the interaction;

FIG. 19 is a schematic diagram illustrating main modules and processes used by the French tense tutoring tool when implementing interactions according to the fourth scenario;

FIGS. 20 and 21 are listings expressing linguistic rules used in the FCG formalism shared by expression and parsing modules of the French-tense tutoring tool as implemented in this embodiment, in which:

FIG. 20 expresses a syntactic rule for expressing/parsing the passé-composé tense in French, and

FIG. 21 is a semantic rule for expressing/parsing the passé-composé tense;

FIG. 22 illustrates an example of attributes of the French-tense tutoring tool configured to teach the future tense, in which:

FIG. 22A illustrates a screen view, including an utterance, that is displayed at the start of an interaction according to the first scenario (human user as student), and

FIG. 22B illustrates part of the task of producing the utterance “la boîte tombera” for the interaction of FIG. 22A; and

FIG. 23 illustrates an example of attributes of a tutoring tool according to the invention configured to teach the Russian aspect system, in which:

FIG. 23A illustrates a screen view, including an utterance, that is displayed at the start of an interaction according to the first scenario (human user as student), and

FIG. 23B illustrates part of the task of producing the utterance “Misha doshagal” for the interaction of FIG. 23A.

### DETAILED DESCRIPTION OF THE INVENTION

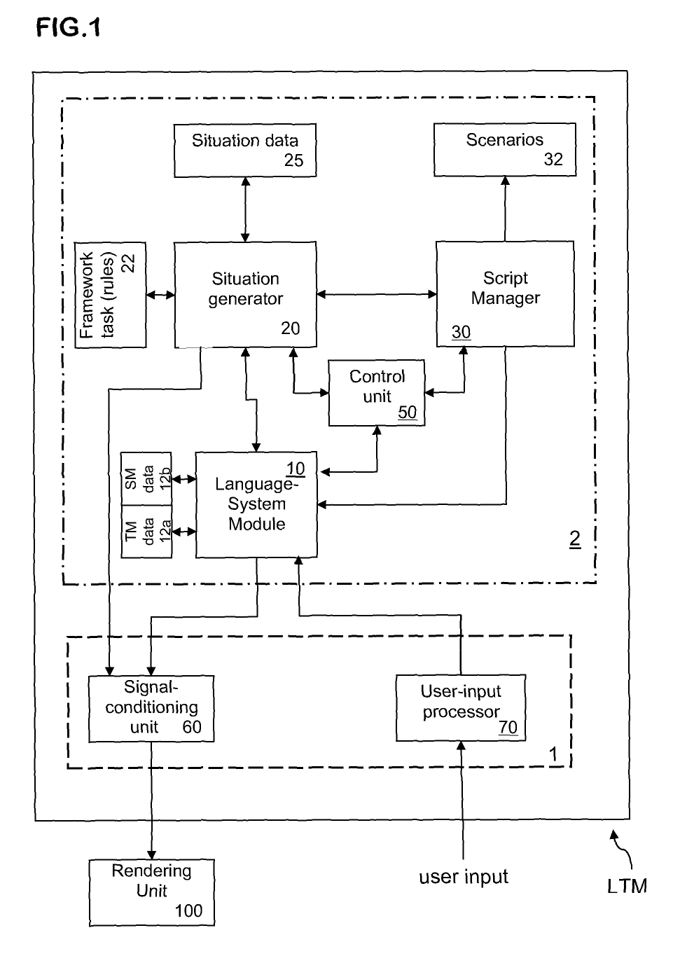

The language tutoring machines and methods of the present invention will now be described in terms of certain presently-preferred embodiments thereof, with reference to FIGS. 1 to 23,

The present invention provides language tutoring machines and methods which generally follow the subtask-based approach described above. In order to allow the learner to focus on acquiring a target linguistic sub-system in a systematic way, the learning environment is structured on the basis of communicative interactions (between the tutor and the learner) during performance of a framework task, in a given context, in which competence in use of the selected linguistic sub-system helps to achieve success in communication. In these interactions, the tutor and learner have a common cooperative goal. Each participant can alternatively play the role of speaker and of hearer so that they can build up competence, both in the production and the understanding of language. The communication takes place within a shared situation (or context) which is a slice of the real world and, in the preferred embodiments of the invention, this context is selected in such a way that the issues addressed by the selected linguistic sub-system show up.

For example, if we want to see the use of an aspect system as in Russian, we could set up a communicative interaction/framework task where the speaker and the hearer both get to see two situations (shown perhaps as video clips) which are only distinguished by the differences in Aktionsart. For example, in one situation a child Masha is reading a book the whole time and in the other a child Misha starts to read a book and then stops immediately. An appropriate framework task consists in answering a question which only makes sense for one of these situations and which requires the expression of Aktionsart, such as “Who is reading a book the whole time?”

Moreover, the present invention “operationalizes” the selected linguistic sub-system so as to represent it in terms of a corresponding “language-system” that is required for language production and comprehension. The teaching process can then be viewed as a process for developing the student's linguistic competence so that the language production and comprehension processes he implements correspond to some ideal configuration of this language-system (which can be designated a “target configuration” or “teacher model”).

In preferred embodiments of the invention, the interactions (contexts, framework tasks) must be designed in such a way that they are relevant for the language-system to be learned. This means that situations and goals must be evoked for which the correct configuration of the language-system plays a role in achieving communicative success. Learners must become aware of the semantic distinctions in the target language-system and this can be aided considerably by enhancing the user interface with representations that suggest the conceptual space involved (such as a timeline in the case of learning about tense and aspect) and contrasting situations in which the distinction is prominent.

Similarly to the previously-proposed, subtask-based approach described above, the present invention makes use of a teacher model and a student model, and preferred embodiments of the invention can employ a teaching strategy which selects the contexts for the interactions based on discrepancies between the student model and the teacher model.

However, according to the preferred embodiments of the invention, the language tutoring machine's representations of the teacher model and the student model for a particular linguistic sub-system correspond to respective operational language-systems which have the same architecture. That is, when being operated to produce or comprehend an utterance involving use of the selected linguistic sub-system, the teacher model language-system and the student model language-system both use the same data structures and procedures to represent the knowledge sources they employ (although the content of the knowledge sources used by the teacher model will, in general, be different from the content of the knowledge sources used by the student model). In other words, using the vocabulary of computational linguistics, in the preferred embodiments of the present invention the internal operational representations of the teacher model and the student model correspond to language-systems using the same “formalism”, but having different “content”.

An utterance has a conceptual structure (i.e. structure in terms of meaning, linguistic categorisations and so on) that can be represented using different logical structures. In the preferred embodiments of the invention the semantic structure in an utterance is conceptualised, in both the internal operational representation of the teacher model and in the internal operational representation of the student model, using the formalism provided by Incremental Recruitment Language (IRL).

In the field of computational linguistics different approaches are used for processing language (production and parsing). In preferred embodiments of the present invention the internal operational representations of both the teacher model and the student model make use of Fluid Construction Grammar for processing language (i.e. expressing utterances which represent particular semantic structures, and parsing utterances). Fluid Construction Grammar (FCG) makes use of constructions which represent different elements of linguistic knowledge and which link form and meaning, but these constructions need not be pre-defined; indeed, Fluid Construction Grammar is designed to allow new constructions to be created, and existing constructions to evolve, based on the success or failure of communicative interactions that make use of those constructions.

According to FCG, a given construction (a type of rule linking form and meaning) is organized in a semantic structure and an associated syntactic structure, each of which is characterised by a respective set of features. The semantic structure decomposes the meaning of the relevant linguistic information into component parts and contains language-specific semantic re-categorisations (e.g. if the linguistic element in question is an occurrence of the verb “put”, the “put” event may be categorised as an action of a type “cause-move-location” which, necessarily, has an “agent” which performs the action, a “patient” which undergoes the action and a “location” where the patient undergoing the action ends up). The syntactic structure decomposes the form linguistic element into constituents and morphemes and contains additional syntactic categorisations such as syntactic features (e.g. number and gender), word order constraints, etc.

Incremental Recruitment Language and Fluid Construction Grammar have often been used for running simulations and experiments involving communicative interactions between a set of artificial language-using agents (notably robots). Amongst other things, those simulations were intended to investigate theories regarding the origin of language. The preferred embodiments of the present invention make use of the IRL and FCG formalisms, and the procedures/structures they provide, in combination, to implement language systems—an operational teacher model and an operational student model—that are capable of producing and parsing utterances during automatic language tutoring.

Advantageously, the teacher model and student model of a given language-system may be implemented using the same components. These components operate at certain times to implement the teacher model of the given language-system and, at other times, to implement the student model of the given language-system, as required for proper operation of the overall language tutoring machine. This is easily achieved when using IRL and FCG to operationalize the teacher model and student model.

A number of significant technical advantages derive from the fact that the teacher model of a given language-system and the student model of that language-system have the same architecture:
a) the development time that is required in order to program a computer-based language tutoring machine so that it can teach a selected linguistic sub-system in a given language is significantly reduced compared to prior proposals;
b) when the same components are used to implement the teacher model and the student model of a language-system the amount of memory needed to implement a language tutoring machine that can teach the given language-system is roughly halved, compared to prior proposals; and
c) a tutor model developed for a first tutoring tool (application) that is designed to teach a language-system in one language (say English) may be re-used, as the initial hypothesis for the student model of a native English speaker, in a different tutoring tool that is designed to teach a language-system in a second language (this idea is developed below).

The first advantage may be better understood by considering the following analogy. A company which designs the machinery necessary to produce telephone directories for one city does not need more design and implementation work to handle production of a telephone directory a second city, all that is needed is to integrate the right data (telephone numbers, addresses, etc.) applicable to the second city, all database issues and issues of layout or lookup are already dealt with. In a similar way, because the teacher model and the student model language-systems share the same formalism, once the data structures and procedures required to implement the knowledge sources of a teacher model have been designed, it is a simple matter to re-instantiate the adopted data structures and procedures to represent the knowledge sources of the student model.

Above-mentioned advantage b) is particularly significant when it is desired to implement the language tutoring machine using a device having limited memory and/or computing power (e.g. in portable devices such as mobile phones, hand-held games consoles, etc.)

The preferred embodiments of the present invention resemble programmed-teaching machines insofar as they provide a computer-based environment that challenges the learner and provides feedback on his or her language use. However, the learning process is not predefined; instead it is structured in terms of the performance of framework tasks which involve routinized forms of communicative interaction which take place in a particular context that is selected, adaptively, so as to challenge a specific feature of language. Preferred embodiments of the invention operationalize the semantics of human languages. Moreover, according to preferred embodiments of the invention, the language tutoring machine makes use of framework tasks and communicative interactions that can be implemented over a network (e.g. the Internet) between two human users so that these users can learn from each other.

As indicated above, in language tutoring machines embodying the present invention, the teacher model and student model are not mere passive descriptions. Instead, they are operational representations which include data sources and functional units which, during language-production and language-comprehension, implement specified operations in relation to data from the data sources so as to produce utterances (phrases, sentences) and understand utterances, in context. Incidentally, in this document the expression “utterance” does not necessarily imply actual speech, the term “utterance” is intended to cover produced language (a word, phrase, sentence, and so on) irrespective of the form in which the produced language is output (synthesized speech, written representation, and so on).

The precise nature of the data structures and functional units/operations that make up a given operational representation of a teacher model or student model are highly dependent on the specific linguistic sub-system and on the language being taught.

So, for example, in the case of a language tutoring machine embodying the invention and configured to teach a lexical language-system which defines vocabulary relating to the naming of particular objects in a target language, the language-systems of the teacher model and student model might include:
a first data set (defining the respective sets of features which characterise the different objects and enable them to be differentiated from one another);
a second data set (defining the names—in the target language—which correspond to the respective different objects described by the feature sets in the first data set); and
a classifier operation which:
   during language production:
   given a set of features describing an object that is to be named, establishes, by reference to the first data set, which object is involved and retrieves, from the second data set, the name which corresponds to this object; and
   during language comprehension:
   when a name is used to describe an object, determines from the second data set which object corresponds to this name and determines, from the first data set, which set of features characterises this object.

In this simple example, the target language-system (the teacher model) and the working approximation of the student's language-system (the student model) both include a first data set, a second data set and a classifier of the kinds described above. However, the “content” is liable to be different because, if the student is just starting to learn the target language-system, the “first data set” in the student model may well include different feature sets to characterise the objects that are in the teacher model's first data set (or lack appropriate feature sets altogether), and the student model's “second data set” may well lack names for objects having feature sets in the first data set and/or include incorrect names for them.

The preferred embodiments of the present invention use FCG constructions to represent linguistic knowledge in the teacher model and the student model (notably, to represent lexical and grammatical knowledge). Usually, at the start of learning, the constructions in the teacher model will be more highly developed (contain more units, more features, more-accurately-assigned categories) than the constructions in the student model. However, FCG procedures are used to develop the student model based on the success or failure of the student's interactions with the language tutoring machine.

In the preferred embodiments of the present invention which use IRL for conceptualization and interpretation in the teacher model and the student model, usually at the start of learning the student model only contains primitive cognitive operations, whereas the teacher model will be more highly developed (containing “chunks”, corresponding to networks of cognitive operations which represent recurring conceptualization patterns in the language-system in question, and different scores associated with chunks, etc). However, IRL procedures are used to develop the student model, allowing it too to store chunks corresponding to networks of cognitive operations that have proven successful during the student's interactions with the language tutoring machine, and enabling it to modify the scores associated with various parameters.

A language tutoring machine according to the present invention is typically created by suitable programming of a general purpose computer. However, it is also possible to build embodiments which consist of application-specific hardware or are a combination of application-specific hardware and appropriately-programmed processors (or other computing modules).

FIG. 1 illustrates schematically a configuration of components that can be used to constitute a language tutoring machine LTM, according to a first embodiment of the invention, which teaches a single target language-system and which uses a single module (10) to implement the operational representations of the teacher model and the student model. The different elements shown in FIG. 1 are identified merely to aid understanding of the various functions that are performed by the language tutoring machine of the first embodiment. Moreover, the distribution of functions between the various components elements shown in FIG. 1 could be changed and/or these functions could be performed using a lesser or greater number of elements than that shown in FIG. 1.

The components involved in teaching a specific language-system can be designated collectively as “a tutoring tool”. In some cases, a tutoring tool that is designed to teach a target language-system for a particular language may be suitable for teaching a corresponding language-system which represents a linguistic sub-system that exists in a different language. For example, a tutoring tool that is designed to teach a language-system relating to the agreement of gender between adjectives and nouns in French, may be suitable to teach a corresponding language-system in Spanish (which uses a gender and agreement system of a generally-similar type).

The preferred embodiments of the invention use tutoring tools whose primary goal is to help in learning the semantic principles underlying a language-system, rather than the rote learning of sounds, words or syntactic forms. Each such tutoring tool will be based on a particular framework task, and a set of situations for which having a correct version of the language-system helps to achieve communicative success. The learner should first understand what the framework task is and can interact with the system through an interface that supports various scenarios (see below).

Although, for simplicity, the following description assumes that the language tutoring machine according to the first embodiment includes only one tutoring tool, in fact, embodiments of the invention can be configured to include two or more tutoring tools (including tutoring tools designed to teach language-systems from different languages). Indeed, examples of such embodiments have been built in which it is possible to shift from learning French tense to Russian aspect with a single click of a mouse button.

Embodiments which include more than one tutoring tool may include multiple sets of the components making up the tutoring tool 2 illustrated in FIG. 1, but greater efficiency is achieved if various of these components are shared by the different tutoring tools. For example the same interface may be used for both of the tutoring tools mentioned above which teach French tense and Russian aspect. Nevertheless, in view of the differences between the knowledge structures and operators which constitute different language-systems, it is likely that each tutoring tool will comprise its own dedicated language-system module configured to provide an operational representation of the respective language-system.

As shown in FIG. 1, the language tutoring machine LTM according to the first embodiment comprises a machine-user interface 1 and a tutoring tool 2 configured to assist learning of a selected language system, LS. The language tutoring machine LTM is arranged to output suitable signals to an external rendering device 100 so that the rendering device 100 can present the user with: a situation (or context) which is the object of communicative interaction between the machine and the user, with utterances (usually in visual form) to be comprehended by the user, with material accessory to performance of a framework task (e.g. instructions or rules explaining what the framework task involves, prompts to elicit user action/input, etc.), with feedback, and with any other required material.

In typical applications, the language tutoring machine LTM is configured to output data to a rendering device 100 which is a display device capable of rendering still images and/or video, possibly with associated sound. This enables the learning tutoring machine to present the user with a visual representation (e.g. a still image or video clip) of a situation or context which will be the object of communicative interaction. However, the invention is not limited having regard to the manner in which the learning tutoring machine presents the user with a visual representation of the context (for example, the learning tutoring machine may designate the selected context by providing reference data identifying an external resource, such as the URL of a particular webpage, the name of a famous artwork, and so on) and, indeed, the invention encompasses cases where no visual representation of the context is generated (because, for example, the context is signalled by aiming a pointer at a physical location which constitutes the context).

As shown in FIG. 1, the machine-user interface 1 includes one or more units 60 configured to process outputs from the tutoring tool 2 so that they can be represented to the user via the external rendering unit 100 as part of a communicative interaction between the machine LTM and the user. This communicative interaction involves performance of a task (here designated “a framework task”) in relation to a context chosen by the machine, and so the requirements of the framework task provide structure in the communication process.

During each communicative interaction, one of the communicating parties (the machine LTM or the user) produces a message/utterance (sentence, phrase, etc.) and the other party reacts to this message, based on their comprehension of its meaning, in a manner directed to accomplishment of the framework task. For ease of understanding, the party producing a message can be designated a “speaker”, and the party trying to comprehend the message can be designated a “listener” even if the message is not actually communicated as an acoustic signal.

The framework task depends on the language-system being taught, but it could, for example, consist in arranging for the listener to select an object that forms part of the context and that is identified in a message from the speaker, arranging for the speaker to describe a specific object in the context, and so on.

In the preferred embodiments of the invention, the user can take the role of speaker as well as the role of listener. Thus, a student can practice language production as well as language comprehension using the language-system in question. Advantageously, therefore, the machine LTM's machine-user interface 1 is configured to receive and appropriately process user inputs which correspond to user messages/utterances, as well user inputs which represent a reaction to a machine utterance. FIG. 1 shows a user-input processor 70 arranged in the machine-user interface 1 for this purpose.

It is convenient to implement the interface 1 between the machine LTM and the user using a graphical user interface and associated GUI-management units of well-known type. It is also convenient to configure the interface 1 to accept user inputs from standard devices such as a keyboard, mouse or other pointing device, and so on. Furthermore, extended interfaces (e.g. gestural controllers, MIDI instruments, etc.) could be used to convey user input to the machine.

In the first embodiment of the invention, the tutoring tool 2 includes: a language-system modelling unit 10 configured to provide an operational representation of the language-system in question LS; a situation generator 20 configured to manage rule data defining framework tasks and to output context data defining a situation or context which will be the object of communicative interactions between the machine and the user during performance of a specified framework task; a script manager 30 configured to handle machine inputs and user inputs sent to the machine-user interface 1, according to scripted procedures; and a control unit 50 configured to control the language-system module 10, situation generator 20 and, if need be, the script manager 30, so as to implement a specified learning strategy.

The control unit 50 is arranged to implement a teaching strategy that decides which situations/contexts are going to be presented to the user. According to the preferred embodiments of the invention, this choice is made in a manner which selects, preferentially, those situations/contexts which are assessed as being likely to lead to an increase in the user's competence in the target language.

In certain of the preferred embodiments of the invention, the teaching strategy also decides which one of a plurality of possible framework tasks is going to be used to structure a given communicative interaction, and the choice of framework task can, once again, be optimized with the same aim of increasing the user's linguistic competence in the linguistic sub-system in question (i.e. teaching him a target language-system). Similarly, in certain of the preferred embodiments of the invention the teaching strategy can be implemented such that, when the language tutoring machine LTM is operating to produce language (an utterance, a sentence) for comprehension by the user, the teaching strategy preferentially selects a meaning that applies to the selected context and which is judged to be likely to make the user's performance closer to the target language-system.

The language-system module 10 has an architecture which embodies a representation of the knowledge sources and operators that make up the target language-system that is to be taught (the so-called teacher model) and, in the first embodiment of the invention (and other preferred embodiments), this same architecture is used to embody a representation in which the content of the knowledge sources and operators is set to produce a student language-system which models the student's current performance in producing/comprehending the selected linguistic sub-system (the so-called student model).

The architecture of the language-system module 10 is an operational representation of the teacher model language-system (and student model language-system), i.e. the language-system module 10 can be controlled (by the control unit 50) so that it produces language for output or comprehends input language, in context, using functional components which represent the knowledge sources and operators of the language-system.

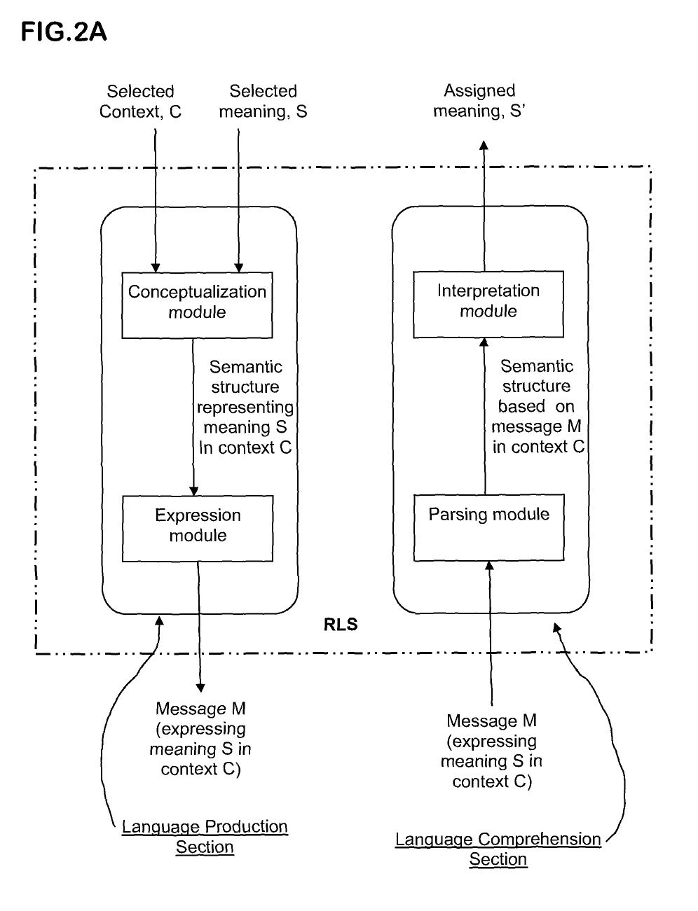

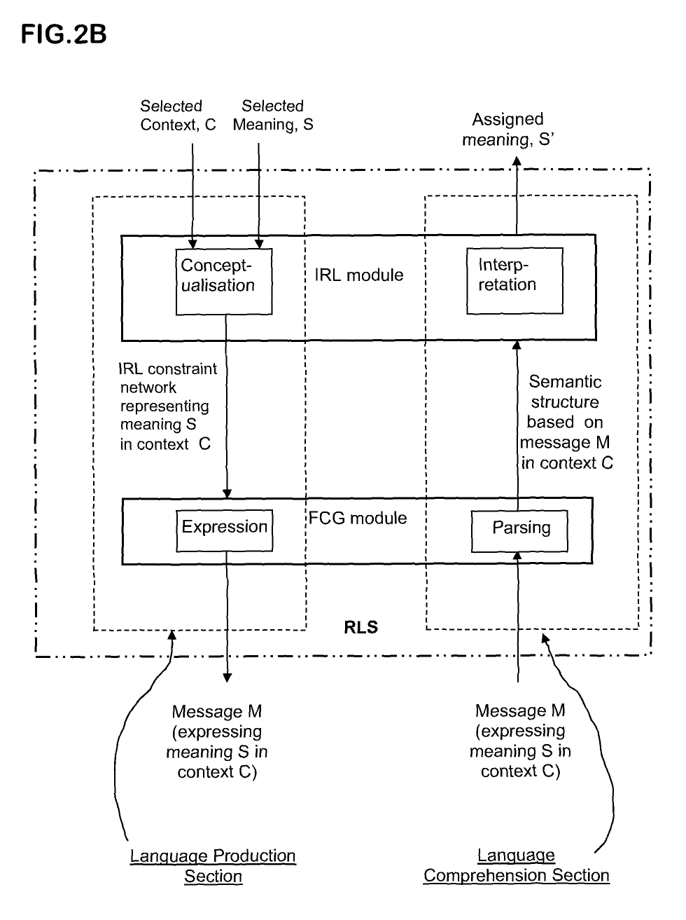

FIG. 2A illustrates, schematically, the main components of the operational representations of a selected language-system—whether it is the teacher model or the student model—that are used in certain embodiments of the present invention. Accordingly, FIG. 2A represents functional modules that are provided by the language-system module 10; however, in view of the non-modular nature of human language, the language-system module 10 may be constructed using inter-connected low-level functional components which co-operate in different ways at different times in order to implement the modules shown in FIG. 2A, such that it may be impossible to find a one-to-one correspondence between the modules shown in FIG. 2 and corresponding sets of functional units in the language-system module 10.

As shown in FIG. 2A, the operational representation of a language-system, RLS, used in preferred embodiments of the invention, includes a section for language production (shown on the left of FIG. 2A) and a section for language comprehension (shown on the right of FIG. 2A).

The language-production section includes a conceptualization module which, given a particular context, C, and a particular meaning, S, to express in relation to that context, produces a semantic structure which corresponds to the desired meaning in context. The language-production section also includes an expression module which produces a message (utterance) M to express this particular semantic structure in the target language.

The language-comprehension section includes a parsing module configured to determine the semantic structure of a message M which expresses some meaning (which is yet to be determined) in a known context, and an interpretation module which decides on what meaning S′ to assign to the determined semantic structure.

In the field of computational linguistics, sophisticated components capable of implementing the above-described functions of conceptualization, expression, parsing and interpretation have begun to appear in recent times. It will be understood that the detailed implementation of these functions in an operational representation of a particular linguistic sub-system depends, naturally, on the knowledge sources and operators of the corresponding language-system, and the task of deciding which detailed implementation of the conceptualization, expression, parsing and interpretation modules is appropriate for a given language-system is straightforward for a computational linguist. Accordingly, it is not appropriate to seek to provide exhaustive details here regarding the implementation of the various modules shown in FIG. 2A. A number of observations will be made, however, for the guidance of the design process.

The invention is not limited having regard to what language technologies are used to implement a language system. However, it is advantageous if the employed technology satisfies the following requirements:
The inventories of concepts, words, and grammatical constructions are represented in such a way that the same representation can be used both for parsing and production (this is called the mirror property).
all components are flexible. The parsing process may be flexible in the sense that it can handle errorful input or can parse utterances even if not all words and constructions are known. The production process may be flexible in the sense that it can produce utterances even if not all aspects of meaning can be covered. Interpretation may be flexible in the sense that it can still interpret meanings even if they are not completely adequate to achieve the communicative goal. Conceptualisation may be flexible in the sense that it may expand the inventory of concepts in case certain concepts are missing.
Every linguistic item in the inventory of the language system may have an assigned score reflecting how much this item is considered to be the norm, and hence how far the speaker/hearer should prefer this item over possible competing items.

In preferred embodiments of the invention the above list of requirements is met by using Fluid Construction Grammar for language processing (notably for the expression and parsing functions indicated in FIG. 2A). It will be understood that FCG is not the only linguistic formalism which uses a common inventory during parsing and expression. However, other linguistic formalisms which make use of a common inventory use respective different processing engines for parsing and for production. This can lead to asymmetries (typically the parser is more powerful than the expression engine) and it becomes difficult to model how production behaviour relates to parsing behaviour. With FCG, on the other hand, a single processing engine performs parsing and expression functions, using the same inventory of concepts, words, constructions, etc. during both processes.

Parsing and production components can have various degrees of sophistication. For example, suppose that the target language system concerns only the teaching of a vocabulary (without grammatical complexity), then conceptualisation amounts to categorisation and production to lexicon lookup. Parsing amounts to reverse lexicon lookup and interpretation to category application. On the other hand, if more complex linguistic features are involved, such as the resolution of pronoun reference or the marking of subordinate clauses, then production and parsing will require the manipulation of symbolic structures because whole sentences need to be handled, and conceptualisation and interpretation may involve complex planning processes. In such cases, it is advantageous if other features of language are scaffolded so as to enable a clear focus to be maintained on the target language system.

The knowledge sources of a given language-system are typically implemented by providing memories or other data storage components in the language-system module 10, and the operators of the language-system are typically implemented by providing the language-system module 10 with functional units (e.g. classifiers, units operable to take into account spatial or temporal perspective, and so on) performing the desired operations. It will be understood that the knowledge sources (memories) will usually store respective different data for the teacher model and for the student model.

As mentioned above, in the preferred embodiments of the present invention the language systems used in the language tutoring machine make use of Incremental Recruitment Language for conceptualisation. Incremental Recruitment Language encodes the meaning of an utterance. It does so using a constraint network whose nodes represent the cognitive operations that are involved in understanding the utterance (examples of such cognitive operations include: filtering sensory input for segmenting or categorisation, operations involving sets, adopting or changing perspective, and so on). For example, if an utterance refers to “the red car” then one of the cognitive operations involved in understanding this utterance is the cognitive operation of filtering the context (which could, for example, be a scene which is described by the utterance) for items that appear to be in the category “car”. The nodes of the constraint network are linked by variables (e.g. the set of items, in the context, that have been identified as “cars”).

It can be considered that conceptualisation using IRL amounts to the creation of a program (a set of cognitive operations and variables) which must be implemented by the “hearer” of the utterance in order to understand the meaning which the utterance is intended to convey. When using Incremental Recruitment Language, conceptualisation amounts to a problem in creating a constraint network which embodies the meaning to be conveyed (constructing a program suitable to allow the meaning to be interpreted), and interpretation amounts to implementing the program specified in a particular constraint network.

Preferred embodiments of the invention that make use of IRL to implement the conceptualisation and interpretation functions benefit from the great flexibility inherent in IRL, for example, the fact that, using IRL, new prototypes, categories, relations and concepts can be created, as needed, for use by the cognitive operations, if the meaning to be conveyed requires it. Moreover, IRL is capable of taking a successful network of cognitive operations and storing it as a chunk which can then, itself, be used as if it were a cognitive operation.

As mentioned above, in the preferred embodiments of the present invention Fluid Construction Grammar is used for language processing (expression and parsing). During expression, FCG builds up a transient feature structure corresponding to the utterance to be produced, by starting from the meaning of the intended utterance. This transient feature structure includes a semantic structure and an associated syntactic structure for the intended utterance. Each of these structures comprises units and associated features. There is a strong correspondence between the FCG semantic structure and the FCG syntactic structure applicable to a given utterance and corresponding units that are present in both structures are generally designated using the same name (although there are cases where a unit that is present in the semantic structure has no equivalent in the syntactic structure, and vice versa).

“Units” in FCG syntactic structures have three features: syn-subunits (which identify sub-units in the syntactic structure which are hierarchically inferior to this unit), syn-cat (which contains the applicable syntactic category(ies)) and “form” (which contains everything that is observable about the portion of the utterance that is covered by this unit, such as the words or sounds, and the word order—for example, the form of a phrase such as “the book” may contain one string for each word and an ordering constraint which indicates that, in this case, the unit that contains all the information about “the” meets—i.e. is adjacent to, the unit that contains all the invention about “book”). The above-mentioned example relating to the “form” feature of a construction can be represented, as follows:
(form
   ((strong article-unit “the”)
   (strong noun-unit “book”)
   (meets article-unit noun-unit)))

Units” in FCG semantic structures have four features: “sem-subunits” (which identify sub-units in the semantic structure which are hierarchically inferior to this unit), “sem-cat” (which contains the applicable semantic category(ies)), “meaning” (which identifies the part of the utterance's meaning that is covered by this particular construction) and “context” (which contains variables that occur in the part of the meaning covered by this unit/construction but are “external” to the present unit in the sense that they are linked to variables occurring in the meaning of other units relating to the overall utterance being processed. The value of “syn-cat” and “sem-cat” features consists of a conjunction of predicates (each, possibly, including arguments) and the predicates can use new categories as they are created.

In FCG the form of an utterance is described in a declarative manner, using predicates, e.g. “precedes”, “meets”, etc., which define ordering relations among the form of units (or any other aspect of surface form, including prosodic contour, stress, etc.).

FCG makes use of rules (or “constructions”) which typically express constraints on the possible mappings there may be between meaning and form. Each rule/construction is associated with a score which reflects how often this rule has been applied in successful communicative interactions. The score helps determine whether this rule will be selected for use during parsing/expression. A rule has two poles: the left pole typically contains constraints on semantic structure and the right pole typically contains constraints on syntactic structure. In both cases the constraints are formulated as respective feature structures having variables. Rules are grouped into subsets, e.g. “morph-rules” which decompose a word into a stem and pending morphemes and introduce syntactic categories, “lex-stem-rules” which associate meaning with the stem as well as valence information and a role-frame, and so on. The order in which rules are applied during expression and parsing depends, at least in part, on the subsets of the rules in questions.

During expression using FCG a choice is made as to which constructions (rules) are relevant to the issue of expressing the meaning to be conveyed (or for parsing the utterance to be understood). The choice of relevant constructions is based, at least in part, on respective scores associated with the various constructions, each score indicating how successful the associated construction has been in communication. Application of a first construction produces an initial configuration of the transient structure representing the utterance and this initial configuration is successively modified as further constructions are selected and applied. The development of the transient structure stops when no more constructions can be applied, or a specified goal has been satisfied (e.g. all words in the utterance have been covered) or a predefined maximum number of search nodes has been reached.

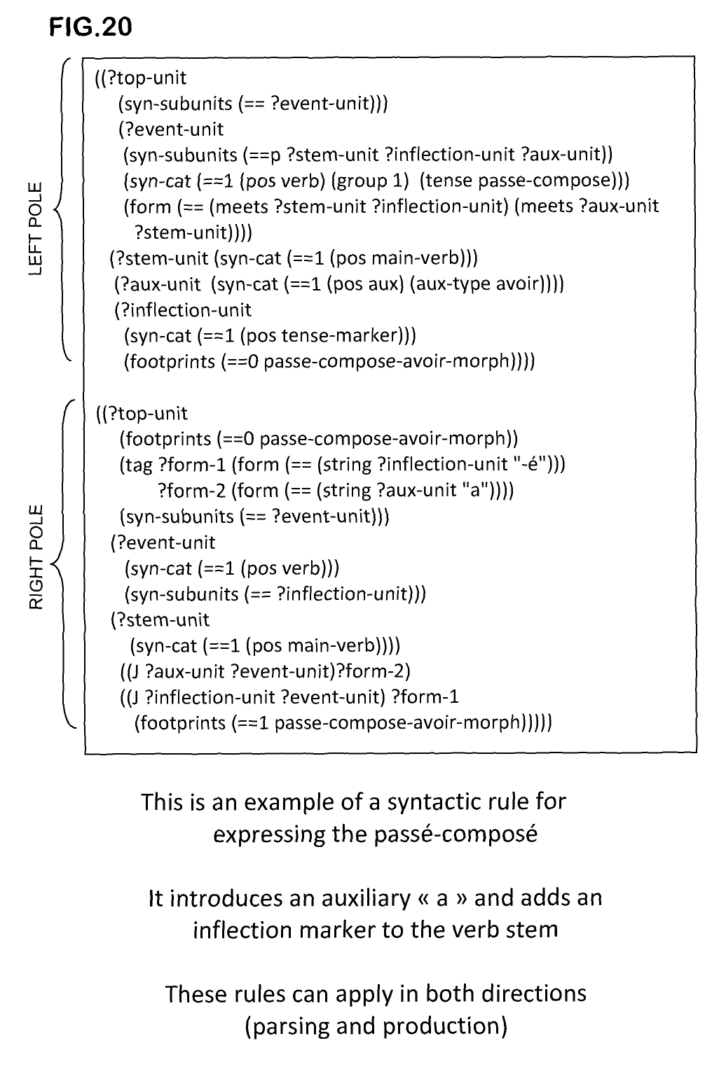

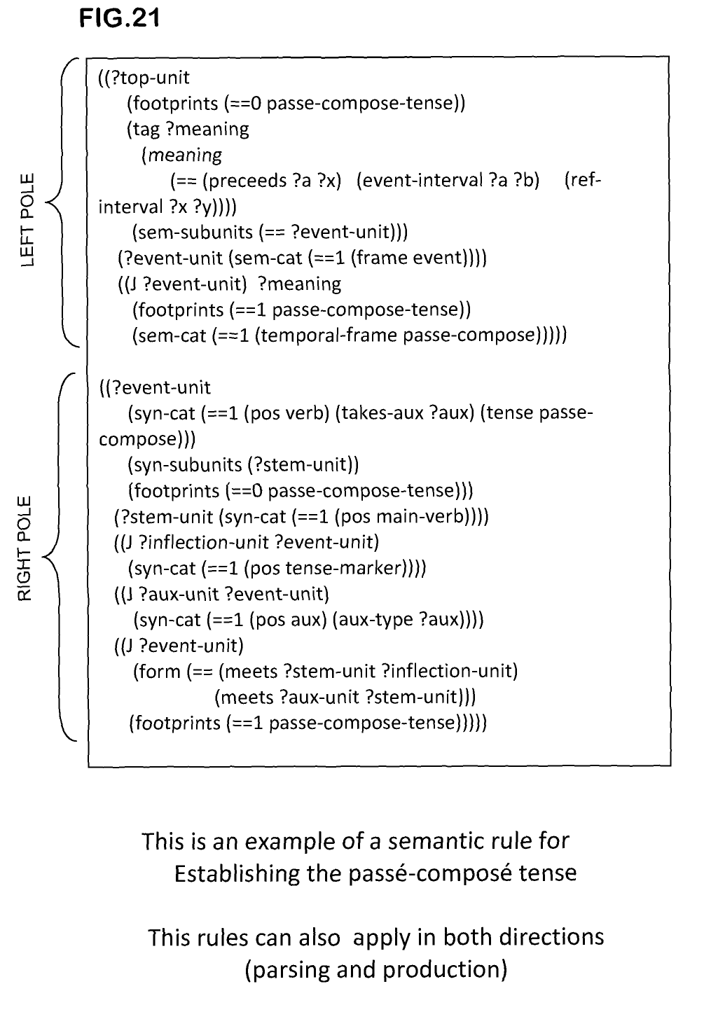

FIGS. 20 and 21 represent some FCG rules in list notation, in which: the prefix ? denotes variables, the symbol==signifies “includes but may also contain additional expressions”, “footprint” designates a feature that is used for controlling rule application (when a rule is applied it leaves a footprint so that this same rule will not be re-applied on the same part of the linguistic structure) and the letter J designates the J operator which is used in FCG to introduce hierarchical structure into a rule.

In FCG all rules are bidirectional, enabling them to be used in expression and in parsing. The rules are applied in association with “unify” and “merge” functions. Typically, application of an FCG rule (construction) involves the steps of:
Matching: one pole of a construction is considered as a set of requirements or constraints on the permissible form of certain feature structures, these particular feature structures are matched with feature structures in the transient structure that corresponds to the utterance. If there is a match, then the transient structure satisfies all the constraint imposed by this construction (rule) and hence “triggers” application of this construction;
Merging: the other pole of the construction is now merged with its corresponding pole in the transient structure.
Development: if both matching and merging have been successful this will lead to a new, more elaborate version of the transient coupled-feature structure corresponding to the utterance, and this in turn may trigger the application of other constructions.

During production this means that the left pole is unified with the semantic structure in the transient feature structure under construction (corresponding to the intended utterance) and, if this process is successful, the right pole is then merged with the syntactic structure under construction. During parsing the right pole is unified with the syntactic structure and parts of the left pole are added to the semantic structure. The unification phase is used to see whether a rule is triggered and the merge phase represents application of the rule. Constraints governed by the J operator do not have to match during the unification phase; instead they are used to build additional structure during the merge phase.

In FIG. 20 the left pole of a syntactic rule relating to the passé composé tense in French is shown in the upper portion of the figure and the right pole of this syntactic rule is shown in the lower portion of the figure. When this rule is applied in production, to help express a given semantic structure, it is run “left-to-right”, i.e. the left pole is matched (“unified”) then the right pole is merged. When this rule is run during parsing, it is run “right-to-left”, i.e. the right pole is matched (“unified”) then the left pole is merged.

Similarly, in FIG. 21 the left pole of a rule (i.e. the semantic pole) relating to the passé composé tense in French is shown in the upper portion of the figure and the right pole of a rule (i.e. the syntactic pole) is shown in the lower portion of the figure. Once gain, when this rule is applied during production it is run “left-to-right”, and when it is applied during parsing it is run “right-to-left”.

Embodiments of the invention which use FCG for language processing (in expression and parsing) benefit from the great flexibility inherent in FCG, notably the fact that the various categories (e.g. lexical categories such as noun, adjective, verb, etc.; possible semantic roles such as agent, patient, etc.; syntactic features such as number, gender, politeness, etc.; and so on) are all open and can be added to.

Embodiments of the invention which use FCG for language processing also benefit from adaptation and consolidation strategies built into FCG, which adapt the scores associated with different rules, categories, constructions, etc. used in parsing/expression, dependent on whether these items are involved in successful or failed communicative interactions. In these embodiments of the invention, it is advantageous for FCG adaptation strategies to be used to adjust the constructions, scores, etc. in the student model so that the model evolves to match the student's changing level of linguistic competence. Similarly, when the language tutoring machine acts as a student, it is beneficial to use FCG adaptation strategies to adjust the teacher model so that it evolves—based on the interactions between the machine and the user—to more closely model the linguistic sub-system being taught by the user.

Embodiments of the invention which use IRL for conceptualization/interpretation also benefit from adaptation and consolidation strategies built into IRL, which adapt scores associated with different cognitive operations, chunks of cognitive operations, etc., dependent on whether these items are involved in successful or failed communicative interactions, which allow successful cognitive networks to be stored as chunks, and that adjust how chunks use operations (e.g. the same cognitive operations that are used in “the red ball” in English and “le ballon rouge” in French can be linked in different ways and this affects the order in which a network is planned and executed). In these embodiments of the invention, it is advantageous for IRL adaptation strategies to be used to adjust the chunks, scores, links, etc. in the student model so that the model evolves to match the student's changing level of linguistic competence. Similarly, when the language tutoring machine acts as a student, it is beneficial to use IRL adaptation strategies to adjust the teacher model so that it evolves—based on the interactions between the machine and the user—to more closely model the linguistic sub-system being taught by the user.

In embodiments of the present invention which use IRL in combination with FCG there is a co-evolution between the conceptual system and the language system: successful conceptualizations will typically enforce lexical-grammatical constructions, and vice versa (successful observations of lexical and grammatical constructions will enforce corresponding conceptualizations).

FIG. 2B illustrates schematically the main components of the operational representations of a selected language-system (teacher model or student model) that are used in preferred embodiments of the present invention which employ IRL and FCG in combination. As illustrated in FIG. 2B, the IRL component and the FCG component can function bidirectionally. That is, the IRL component can use its inventories of cognitive operations (both primitive operations and chunks) both during conceptualisation (production of a constraint network which conceptualises a meaning that is to be conveyed), and during interpretation (determination of the meaning represented by a given semantic structure). Similarly, the FCG component can use its inventory of constructions, both during expression (production of an utterance that corresponds to the semantic structure embodied in the constraint network output by the IRL component) and during parsing (generation of a semantic structure which corresponds to a received message/utterance).

Incremental Recruitment Language and Fluid Construction Grammar are well-known systems in the field of computational linguistics and have been fully described in the literature in this field (see, for example “Constructivist Development of Grounded Construction Grammars” by Luc Steels, in Proceedings of the Annual Meeting of the Association for Computational Linguistics, ed. W. Daelemans, 2004, “Unify and Merge in Fluid Construction Grammer” by Luc Steels and Joachim de Beule, in Lecture Notes in Computer Science, Vol. 4211, pp. 197-223, Springer Verlag, Berlin, 2006, and “Planning What to Say: Second Order Semantics for Fluid Construction Grammars” by Luc Steels and Joris Bleys, in Proceedings of CAEPIA '05 ed. A. Bugarin Diz and J. Santos Reyes, Lecture Notes in AI, Springer Verlag, Berlin, 2005). Moreover software implementing IRL and FCG can be downloaded from the Internet at http://www.fcg-net.org). Accordingly, no further details are required here (and no claim is being made to IRL or FCG per se). However, preferred embodiments of the present invention make use of IRL and FCG in an innovative manner to help provide improved language tutoring machines having advantageous properties as described in this document.

In the first embodiment of the present invention, when the language-system module 10 is being controlled to produce language or to comprehend language according to the teacher model, the functional units (classifiers, etc.) of the language-system module 10 perform their specified operations based on “teacher model” data in the knowledge sources (e.g. FCG constructions, scores, etc. applicable in the teacher model, IRL cognitive operations/chunks, scores in the teacher model). In a similar way, when the language-system module 10 is being controlled to produce language or to comprehend language according to the student model, the functional units (classifiers, etc.) of the language-system module 10 perform their specified operations based on “student model” data in the knowledge sources (e.g. the FCG constructions, scores etc. and/or IRL cognitive operations/chunks, scores, etc. that have been developed for the student model so far).

The knowledge sources and operators which make up a particular language-system, as well as the content of those knowledge sources are known (explicitly or implicitly) to native speakers of the language containing the corresponding linguistic sub-system although, depending on their cognitive powers and linguistic proficiency, different native speakers may have different opinions on the precise content of the knowledge sources. Accordingly, it is possible to build an accurate operational representation of a particular language-system (i.e. a teacher model) by explicit design using functional units and data sources which model this pre-existing knowledge available from native speakers (and analysts of the language in question). Typically this design process amounts to a programming operation. On the other hand, design of an appropriate student model is not so easy because the student's conception of the language-system is changing all the time as the learning process proceeds and the student model needs to develop in a corresponding manner.

In those preferred embodiments of the invention which use FCG, evolution of the student model is handled by procedures, built into Fluid Construction Grammar, which control the way in which grammatical constructions used in the operationalized student model evolve (and are created), and which can update the “scores” associated with constructions, categories, etc. dependent on how successful or unsuccessful this construction, category etc. has been in communicative interactions. Similarly, in those preferred embodiments of the invention which use IRL, evolution of the student model is handled by procedures, built into IRL, which control the way in which the IRL inventories (e.g. of cognitive operations) evolve dependent on whether there has been success or failure in communication.

In preferred implementations of the present invention, a given language tutoring machine is designed to be able to assist more than one user in learning a particular language-system. Thus, it is necessary for the language tutoring system to be able to set up and maintain a respective student model for each student who interacts with the language tutoring machine. Each such student model will represent the state of knowledge/proficiency of the corresponding student.

Moreover, in embodiments of the invention which provide plural tutoring tools (i.e. which are designed to assist users in learning more than one target language-system), each tutoring tool is adapted to set up and maintain a respective student model for each user who interacts with this tutoring tool of the language tutoring machine.

Taking into account the fact that, in preferred embodiments of the invention, the learning strategy selects contexts and utterances (and, if appropriate, framework tasks) for presentation to a user/student based on an analysis of the aspects of the student model which are different from the teacher model, it is clearly advantageous if the student model is an accurate approximation to the student/user's current state of knowledge in regard to the language-system in question. More particularly, the teaching process will tend to bring the student's performance into line with the target language-system using fewer interactions if the student model is an accurate representation of the student's actual performance in producing/comprehending the linguistic sub-system in question.

As indicated above, in the preferred embodiments of the present invention, the architecture (data sources, functional units, and so on) of the operational representation which embodies the student model is the same as the architecture of the operational representation which embodies the teacher model. However, it is still necessary to determine what content should be in the knowledge sources of the appropriate student model when a given student first starts using a given tutoring tool of the language tutoring machine. This initial content will be enriched/updated by the tutoring tool based on whether or not there is success in communication when the student engages in communicative interactions with this tutoring tool of the language tutoring machine.

One possible approach for determining the content of the student model at start-up (that is, at the start of a particular student's interaction with a given tutoring tool in the language tutoring machine) is to configure the tutoring tool so that, at start-up, the student model for this student has empty knowledge sources (i.e. the memories/storage units contain no feature sets, taxonomy, or other data in respect of the student model; in embodiments where FCG is used, initially there are no constructions; and, in embodiments where IRL is used, only primitive cognitive operations are included). However, this default approach equates to an underlying assumption that users who have not yet learnt the particular conceptualization of reality which is inherent in the target language-system have no conceptualization of reality whatsoever.

In fact, students will tend to have a conceptualization of reality which is based on notions inherent in their native language. Accordingly, a more efficient approach for setting the content of the student model at start-up consists in assuming that this content should be based on concepts and conventions that are used in the student's native language. In practice this means that, in embodiments where FCG is used, certain lexical and grammatical constructions from the student's mother tongue can be included in the initial student model and, in embodiments where IRL is used, certain chunks and scores for cognitive operations applicable in the student's mother tongue can be included in the initial student model.

In embodiments which use both IRL and FCG, the IRL inventory adopted from the student's mother tongue can be exploited for predicting the kind of conceptualizations/interpretations the student is likely to make, and FCG can then be used for predicting the kind of grammatical structures the student may build based on these conceptualizations. The adopted constructions can initially be used without modifications, and the teacher can run diagnostics and repair strategies in order to foresee possible problems and discrepancies with the target language-system. The adopted FCG constructions, IRL chunks, etc. then form the basis for possible repair strategies.

The same methodology is used for deciding which constructions, cognitive operations etc. from the student's mother tongue should be adopted for the initial student model of a given language-system as is used for determining which constructions, cognitive operations etc. are needed for implementing the target language-system. If there is a corresponding sub-system in the student's native language then all cognitive operations, constructions and language strategies that are needed in the relevant sub-system of the student's native language should be operationalized in the initial student model For example, in a language tutoring machine configured to teach the Russian aspect system, if the student is assumed to have English as their mother tongue then it is beneficial to configure the initial student model using constructions, etc. from the tense-aspect system in English (in English the aspectual system is strongly interwoven with tense).

Using this enhanced approach, the student model at start-up will tend to be a closer approximation to the user/student's actual state of knowledge of the linguistic sub-system in question than would have been the case using a student model having empty knowledge sources.

Embodiments of the invention which employ one or more tutoring tools which set the initial content of a student model based on concepts/conventions which apply to the student's mother tongue may be configured to prompt new users to input information identifying their mother tongue. These embodiments may be designed so that the relevant tutoring tools set the same predefined initial content of a student model for all users/students who have the same mother tongue. Alternatively, such embodiments may be configured to prompt the user to supply additional data relating to his linguistic capabilities, e.g. regarding his level of competence in the language containing the selected language-system (or in any other second language), and to differentiate the initial content that is set in the student model, dependent on this additional data.

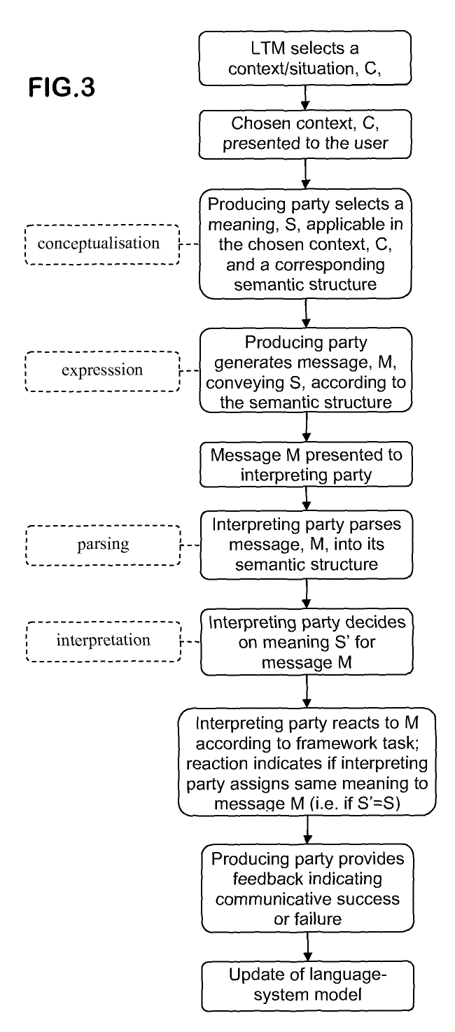

Now that the major features of the language tutoring machine LTM according to the first embodiment have been described, a description will be given of various communicative interactions which are supported by this machine LTM, with reference to FIGS. 3 to 5.

The language tutoring machine LTM according to the first embodiment of the invention is configured to accommodate different communication scenarios. In a first scenario, the “speaker” is the language tutoring machine, acting as a tutor, and interacting with a user who has the role of student. In this first scenario the user/student practices language comprehension. In a second scenario, the “speaker” is the user, still playing the role of student, and the listener is the language learning machine. In this second scenario the user/student practices language production. In both cases, the language tutoring machine is configured to select contexts (and, in some cases, framework tasks, and/or specific utterances) which expose the student to the language-system in question.

The particular scenario that applies at a given time will, generally, depend on a choice made by the user (who can use a graphical user interface or other input device to indicate whether he wishes to practice language production or language comprehension at that time). The way in which the communicative interaction will unfold depends, amongst other things, on the chosen scenario. The script manager 30 controls the outputs to the user so as to ensure that material is presented to the user (notably via rendering device 100) in an order and presentation which matches the selected scenario and framework task.

FIG. 3 is a flow diagram indicating the main steps that are included in communicative interactions implemented using the language tutoring machine of the first embodiment, and is generic to the first and second scenarios. FIG. 3 is labelled to indicate at which stages in the interaction the processes of conceptualisation, expression, parsing and interpretation are performed. In FIG. 3 the “producing party” is the party (LTM or user) who produces language during his communicative interaction (“the speaker”), and the “interpreting party” is the party (user or L™) who tries to understand the message (“the listener”). In the second scenario, the roles of speaker and listener are reversed compared to their allocation in the first scenario. In general, the user performs the processes of conceptualisation, expression, parsing and interpretation without being conscious of the separate steps involved in these processes.

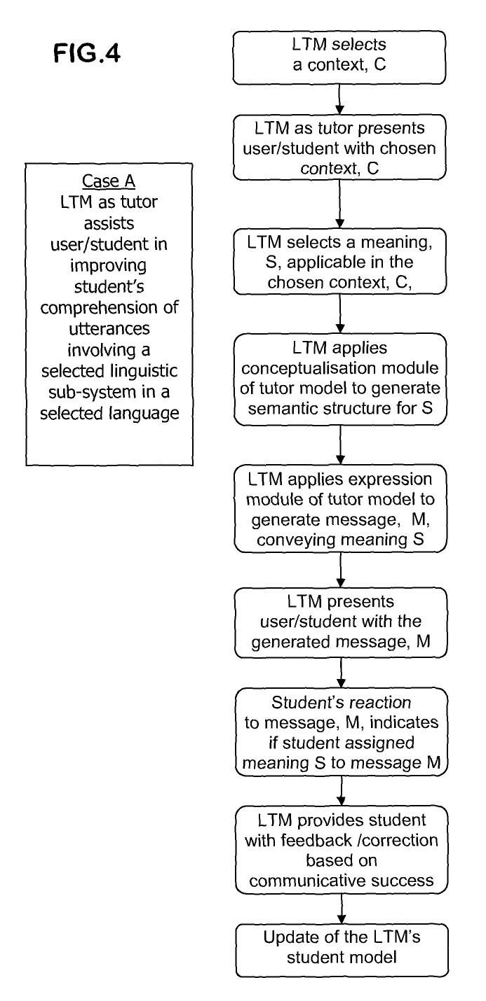

FIG. 4 is a flow diagram illustrating the general structure of a communicative interaction according to the first scenario, i.e. when the tutor/LTM machine is producing language and the student/user has the role of listener. In this first scenario, the tutoring machine LTM produces language in a given context, the user interprets the utterance/message in the selected context (which has been signified to him, for example, by display of an image which represents the context) and the user reacts to the utterance/message with the aim of achieving a framework task in a manner which reflects the user's understanding of the utterance/message. Typically the user's contribution to accomplishment of the framework task will be signalled to him, for example, by an on-screen instruction.

More particularly, in this first scenario:
1. The artificial tutor selects a situation/context and a communicative goal.
2. The artificial tutor uses its language system to produce an utterance that achieves the goal.
3. The human learner attempts to understand the utterance and reacts by performing an action according to a script appropriate to the framework task and context.
4. The artificial tutor compares this response to the expected response and provides feedback and, possibly, correction.

In preferred implementations of the invention, this basic version of the first scenario can be enhanced when the learning strategy is designed to take the state of the student's knowledge (as represented by the student model) into account when setting up elements of the interaction. According to this enhanced scenario:
1. The artificial tutor selects a situation and a communicative goal. The situation and the goal are now selected in function of the existing Student Model.
2. The artificial tutor drives its operational representation of the teacher model to produce an utterance that achieves the goal. The Student Model can be used so as to choose an utterance that is likely to be understood (possibly after inference or learning) by the learner.
3. The human learner attempts to understand the utterance and reacts by performing an action according to a script appropriate to the framework task and context.
4. The artificial tutor compares this response to the expected response and provides feedback and, possibly, correction. At the same time the artificial tutor updates the student model using the learning and alignment functions of its language strategy.

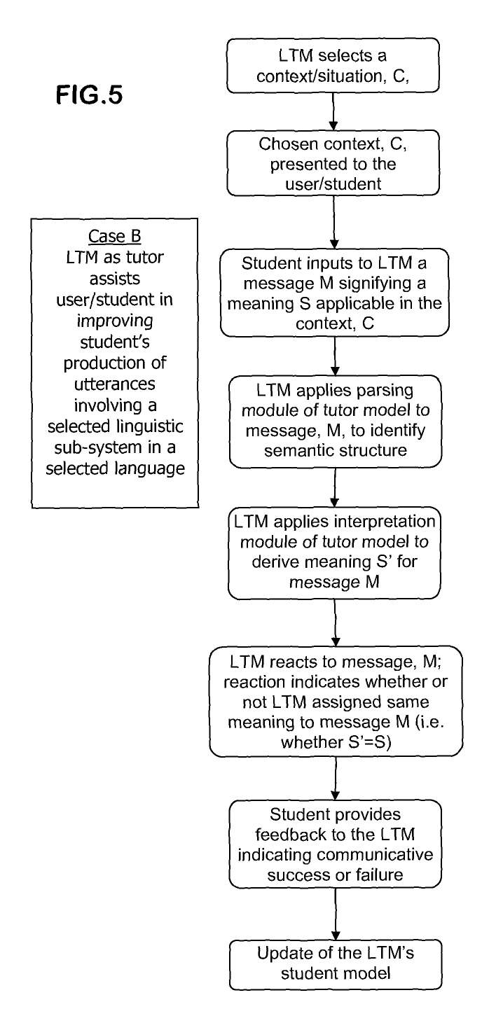

FIG. 5 is a flow diagram illustrating the general structure of a communicative interaction according to the second scenario, i.e. when the user/student is producing language and the tutor/machine serves as listener. It involves the following steps:
1. The artificial tutor selects a situation but not the communicative goal.
2. The human learner selects a communicative goal and produces an utterance to achieve that goal.
3. The artificial tutor reacts to the utterance by performing an action according to the script of the language game.
4. The human learner compares this response to the expected response and signals his reaction.
5. The artificial tutor compares this response with the one expected and gives additional correction and/or feedback.

Once again, the second scenario can be enhanced by taking the student model into account when setting up the interaction. In this case, because the human learner becomes an active speaker in the second scenario, there is even more data available to the tutoring tool for building a good student model. According to the enhanced second scenario:
1. The artificial tutor selects a situation but not the communicative goal. The selection of the situation takes into account the student model.
2. The human learner selects a communicative goal and produces an utterance to achieve that goal.
3. The artificial tutor tries to comprehend the utterance and then reacts by performing an action according to a script which depends on the framework task. The tutoring tool could potentially use the student model to help in comprehension of the utterance (what did the student mean).
4. The human learner compares this response to the expected response and signals his reaction. This reaction is needed by the tutoring tool in order to be able to refine its student model.
5. The artificial tutor compares this response with the one expected and gives additional correction and/or feedback.

In both of the enhanced scenarios, the active use of a student model has the following advantages (1) the situation and communicative goal can be chosen in order to maximise the learning benefit for the learner, given his or her inferred state of knowledge, and (2) it makes comprehension more flexible because errorful input can nevertheless be handled by the tutoring tool.

In certain preferred embodiments of the invention, the computational module used to implement the teacher model (and/or student model) is a “learning component”, that is, it is a module which can build up its representation of a language-system automatically, instead of requiring explicit programming.

This component should not only be able to acquire words, constructions, or meanings. It should also handle the ‘creative’ expansion of the language inventory for novel cases without loosing the available systematicity in the language, and the alignment of a language-system to that of another interlocutor. These features can be provided, for example, by using a learning component which comprises a module which employs Fluid Construction Grammar for language processing (in view of procedures for alignment, repair, diagnostics, etc which are built into FCG) and/or which comprises a module which employs Incremental Recruitment Language for conceptualization/interpretation (in view of its corresponding alignment, repair and diagnostic procedures). Incidentally, repair procedures built into FCG comprise solutions for (communicative) problems that occur during processing. For example, general repair strategies can be predefined in FCG to handle respective cases such as the case of an unknown word being encountered during parsing (repair=FCG can insert a generic lexical construction and then try to infer more information about this construction via the grammatical and communicative context), or a known word used in a novel syntactic pattern (repair=FCG can relax its processing constraints by skipping the matching phase during rule application, and determining whether, nevertheless, a sensible parse/expression can be found), and so on.

It is an advantageous feature of the present invention that learning components of this kind can develop their representations of the language-system in question automatically, simply by engaging in the language tutoring machine's prescribed type of communicative interactions as framework tasks are performed.

Thus, when a learning component is used to implement the operational representation of the teacher model, it can learn its representation of the target language-system automatically, i.e. without explicit programming, via interactions between the language tutoring machine and a user who has linguistic competence in regard to the linguistic sub-system in question, in a situation where the expected roles of the machine and the user are reversed (the user becoming the tutor and the machine becoming the student). When such a learning component is used to implement the student model, it can learn its approximation to the student's current version of the language-system automatically through ongoing interactions between the machine and a user in situations where the user is the student and the machine is the teacher.

Preferred embodiments which make use of learning components in this way make it possible for a person who is unfamiliar with computer programming and instructional design, but competent in using a target language-system in a given language, to develop a tutoring tool for teaching the target language-system. Thus, it is no longer the responsibility of the machine-designer to develop specific hardware or explicit programming so that the language tutoring machine can serve as a tutoring tool for a particular language-system/linguistic sub-system, he can merely provide the language tutoring machine to a competent native speaker (e.g. a language teacher) who can develop the tutoring tool via naturalistic and intuitive interactions with the machine. Moreover, the machine-designer need no longer needs to develop specific hardware or programming so as to produce tutoring tools for all possible language-systems in all possible languages. Instead, as and when a tutoring tool for a specific language-system in a given language becomes necessary, a native speaker can be brought to interact with a language tutoring machine according to these certain embodiments of the invention in order to teach the relevant language-system to the teaching model in the machine.

Moreover, with preferred embodiments which make use of learning components in this way it is possible to develop sophisticated student models automatically and these are then available to personalize the student's learning experience.

A language tutoring machine according to a second embodiment of the invention, using a learning component, will now be described. The second embodiment has the same general architecture as the first embodiment represented in FIG. 1, except that the target language-system module 10 is implemented using a learning component. Thus, in this second embodiment of the invention, a single learning component is used to implement the operational representation of the teacher model and that of the student model. (In variants of the second embodiment, two separate learning components are used as the modules which embody the operational representations of the teacher model and the student model. However use of a single learning component to implement the operational representations of the teacher model and of the student model leads to a significant reduction in the number of low-level functional units that are required in order to build the language tutoring machine and, in addition, the time taken to design these functional units is somewhat reduced). The same reference numerals as were used in relation to the first embodiment will be used to designate corresponding elements of the second embodiment.

In the second embodiment of the invention new scenarios for communicative interaction between the user and the language tutoring system are supported, additional to the first and second scenarios that were already supported in the first embodiment. In a third scenario, the “speaker” is the user, now playing the role of tutor, and the “listener” is the language learning machine, now serving as the student. In this third scenario the learning module implementing the language tutoring system's language-system module 10 practices language comprehension. In a fourth scenario, the “speaker” is the language tutoring machine, again acting as a student, and interacting with a user who has the role of tutor. In this fourth scenario the learning module implementing the language tutoring system's target language-system module 10 practices language production. In both of these new scenarios, the context in which the communicative interaction takes place is still selected by the language tutoring machine.

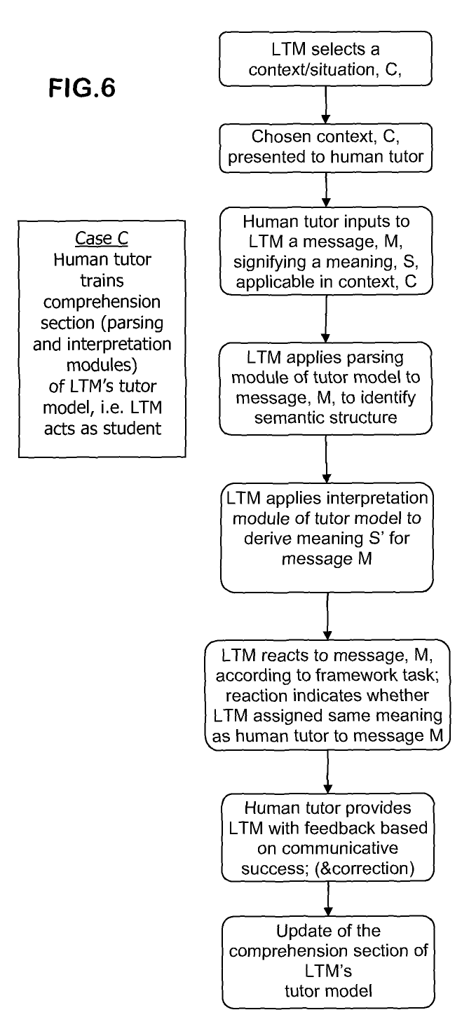

FIG. 6 is a flow diagram illustrating the general structure of a communicative interaction according to the third scenario, i.e. when the human user/tutor is producing language and the language tutoring system has the role of listener. According to the third scenario:
1. The tutoring tool of the language tutoring machine selects a situation but not the communicative goal.
2. The human user/tutor produces an utterance (possibly by selection from a given set).
3. The tutoring tool reacts to the utterance by performing an action according to a script which depends on the framework task.
4. The human user/tutor compares this response to the expected response and provides feedback and possible correction.
5. The tutoring tool adjusts its operational representation of the teacher model language-system based on this feedback.

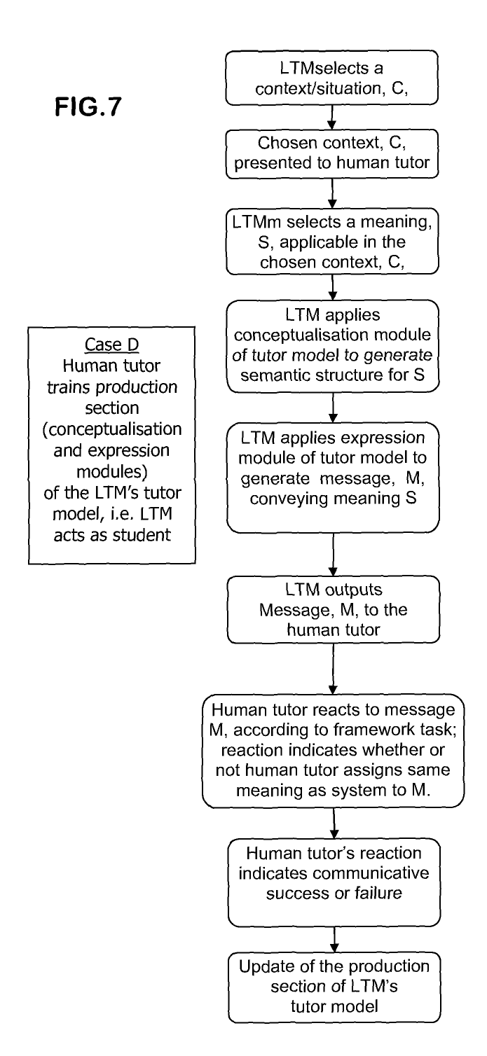

FIG. 7 is a flow diagram illustrating the general structure of a communicative interaction according to the fourth scenario, i.e. when the language tutoring machine plays the role of student and practices language production, and the user/tutor serves as “listener”. According to this fourth scenario, the tutoring tool of the language tutoring machine can actively investigate gaps in its language system (i.e. areas of the operational representation of the teacher model which may be deficient). According to this fourth scenario:
1. The tutoring tool selects a situation and a communicative goal.
2. The tutoring tool produces an utterance, possibly expanding the usage of its existing repertoire to new cases.
3. The human user/tutor reacts to the utterance by performing an action according to a script which depends on the framework task.
4. The tutoring tool compares this response to its expected response and adjusts the operational representation of the teacher model accordingly.

At present, a universal learning component which would be suitable for building operational representations of all possible language-systems in all possible languages has not been built and it may never be built in view of the rich variation found in human languages. However, it is possible—for example using an FOG component and/or IRL component—to build a learning component that is capable of learning a set of related linguistic sub-systems, for example the concept of “aspect” in Slavic languages. (Russian, and other Slavic languages, are famous for having a very elaborate verbal grammatical aspect system known as Aktionsart, which expresses distinctions about the temporal structure of an event, such as whether an event is successfully completed or not, whether it is a repeated action, whether the speaker focuses on the beginning or on the ending, and so on.)

When designing a learning component so that it is adapted to be an operational representation of a teacher model/student model relating to a particular kind of language-system, the chosen design must ensure that the learning component knows which semantic aspects of the situation it should pay attention to (even though in a specific language there could still be significant differences in how those aspects are categorised) and it knows how these semantic aspects are translated to grammar (for example Russian uses prefixes for marking aspect but another language could use auxiliary verbs).

The following description provides information on two examples of language tutoring tools that have been developed to embody several of the above-described aspects of the invention.

### First Example Tutoring Tool

### Generic Colour Terms Tutor

The linguistic sub-system being taught by the first example tutoring tool is a lexical system of colour terms. This first example tutoring tool is designed to teach colour terms which name categories of colour which are grounded in the user's perceptions. It is a straightforward matter to configure the lexicon and colour categories that are used in the teacher model of this tutoring tool so that it can teach the names that are assigned to perceptually-grounded colour categories in substantially any language, without changing the operators that are used in the operational representation of the teacher model. In other words, in order to change the language of the colour terms that this tutoring tool is teaching, it is sufficient to change the content of the knowledge sources in the operational representation of the teacher model, while leaving the operators unchanged. Accordingly, this first example tutoring tool can be designated a “generic” colour term tutor. A generic tutoring tool of this type may be provided ready equipped with data defining the appropriate content of the knowledge sources for teaching colour terms in different languages—in which case the control unit of the tutoring tool selects the appropriate set of content data in dependence on the particular language to be taught at a given time. In general there are only limited cases where a given tutoring tool can be generic to a range of linguistic sub-systems. For example, a tutoring tool adapted for acquiring Russian aspect may also be useable for acquiring Ukranian aspect but would not be helpful for acquiring aspect in other languages.

In this example, the colour-term tutoring tool was configured in accordance with the above-described second embodiment of the invention, so as to use a learning component to implement the operational representation of the teacher model and student model. Accordingly, interactions between the tutoring tool and a user according to any of the above-described first to fourth scenarios were supported.

A language tutoring machine including this colour-term tutoring tool was implemented using a general purpose computer apparatus (which could have been substantially any computer and any operating system—Windows, Linux, Mac OS, and so on) that had an operational common LISP system, was loaded with Fluid Construction Grammar and was running the computer program whose program listing is annexed hereto as Annex A.

This first example language tutoring tool (and, indeed, the second example language tutoring tool discussed below) was loaded with FOG as part of Babel2, a testbed for computer simulations involving adaptive interactions between agents. Babel2 may be considered as a toolkit which includes IRL as a framework for conceptualisation/understanding and FCG as a framework for expression and parsing. Babel2 also includes a framework for handling scripted interactions between multiple agents (configured, in this case, to handle the scripting of interactions between the tutoring tool and a human user), as well as a meta-level structure which enables diagnostics to be run, allows situations and contexts for communicative interaction to be chosen (customized, in these embodiments of the invention, to enable teaching strategies to be planned) and that allows various processes in the system to be monitored (e.g. enabling monitoring of the evolution of the student model), and a web interface (supported across platforms on most browsers, e.g. Safari, Firefox, Google Chrome, etc.).

Babel2 was developed as a toolkit containing building blocks to enable researchers to develop and implement their own specific linguistic experiments/simulations involving communication between multiple agents and, as such, it is open-ended and extensible. Babel2 takes an object oriented approach, defining a set of macros, generic functions, functions, global variables, monitors, task-and-processes and structs that can be specialized by the designer dependent on the specific experiment he has in mind, to form a desired cognitive architecture. The reusable building blocks provided by Babel2 enable the formal structure of an inter-agent interaction to be described, the main elements of the environment to be represented and models of the agents' memories and learning processes to be developed.

The features of Babel2 have been fully discussed in the technical literature in this field, and the techniques necessary to develop a specific implementation using Babel2 are well-known in the field of computational linguistics. In this connection, reference is made to the Babel2 Manual, by Loetzsch et al, AI-Memo 01-08, AI-Lab VUB, Brussels, Belgium, 2008 which can be downloaded from http://arti.vub.ac.be/˜pieter/Babel %202%20manual.pdf It is, thus, sufficient to limit the current discussion to highlighting certain specific features of the configuration of Babel2 that was used in the present example language tutoring tools (and gave rise to the code listed in Annexes A and B).

In the present implementations of Babel 2, Common Lisp was used. Other languages (e.g. Java) could be used for developing the Babel implementation used in the tutoring tools but Common Lisp provides the advantages of rapid execution and relatively low memory usage. Indeed, in this implementation, Babel2 was entirely implemented in portable Common Lisp (and is known to work, at least, on the Lisp implementations of LispWorks, CCL and SBCL and probably on other Common Lisp implementations).

In the example language tutoring tools discussed here, it was sufficient to use only the “systems” and “libraries” sub-directories of Babel 2. Of the modules in the “systems” sub-directory of Babel2, the fcg-2, irl, experiment-framework, tasks-and-processes, monitors, web-interface, utils and test-framework modules were used in implementing the example language tutoring tools.

In the example language tutoring tools discussed here, the human user was modelled using the “agent” class defined by Babel2. The types of interactions between agents (i.e. tutoring tool and human user) that were defined for the tutoring tools were specified using instances of the Babel2 class “action” (examples of such actions included “signalling failure or success”, “speaking”, etc.). The “world” Babel 2 class was specialized based on the desired context of the interactions between the tutoring tool and the human user. The interaction script was implemented in Babel2 through methods for planning actions (based on the “world” and on the last “action”) and methods for performing actions, i.e. the script was not predefined. For example, if the human user's action showed that he had incorrectly interpreted a colour expression (e.g. he clicked on an incorrect patch of colour in response to seeing the colour expression) then the tutoring tool planned its next action based on the human's last action (clicking on an incorrect colour) and on the “world” in its current state. The tutoring tool's selected action was then performed (e.g. providing the user with feedback on his action), and this could itself change the state of the “world”. By using a planning process to determine the next action the interaction script was able to be more flexible than a fixed and completely routinized script.

The example language tutoring tools make use of specialized instances of the “monitors” class provided in Babel2, for example to inform the human user about communicative success or failure, or other scores, to allow the user to visualize aspects of the student model (e.g. his/her lexicon of colour terms), to allow the user to visualize past interactions, etc.

The example language tutoring tools made use of customizable procedures (designed to enable situations and contexts of a communicative interaction to be selected) provided in the tasks-and-processes module from Babel2 to enable different teaching strategies to be defined and selectively implemented (the selected teaching strategy at a given time depending on, for example, the evolving student model, the student's motivational state, or other selected factors). For example one teaching strategy based on the evolving student model can operate such that when a lexical gap is detected in the student model the subsequent teaching concentrates on vocabulary. Another teaching strategy that can be accommodated treats the linguistic knowledge to be taught as a curriculum. This curriculum is represented as a directed acrylic graph of topics (which may be structured into sub-graphs of sub-topics) organised in terms of prerequisites. For example, basic topics could consist of topics relating to language syntax, whereas advanced topics could cover complex tense structures. This teaching strategy would not present the curriculum to the student via a linear presentation but would instead manipulate the learning path to suit (and entertain) the student, with the assessment being based at least in part on the student model.

The colour-term tutoring tool constituting the first example language tutoring tool made use of a learning strategy in which each of the possible situations (or contexts) that the tutoring tool could select as the object of communication between the tutoring tool and the user corresponded to a collection of examples of different colours, and this context was represented to the user visually (notably, by displaying the collection of examples on a display screen).

The tutoring tool supported a case where each collection of examples was presented to the user by displaying a certain number of standardized patches of colours of different hues (e.g. so-called Munsell chips) on the display screen. The examples that were included in each collection could be selected randomly from Munsell chips. However, it was found advantageous to create a given collection of examples (context) by putting together examples of colours that correspond to prototypes in the tutor model (i.e. putting together examples of colours which exemplify different colour categories that are named using respective different colour terms). Moreover, it is not essential for the example colours in each collection to be represented using standardized patches on a screen, the example colours may be presented by displaying a picture of a real world scene and highlighting coloured areas within the scene.

In this application it was not essential to store explicit data defining each possible context or, even, explicit data defining all the possible colours that could be used in each context. Instead, in view of the fact that any given colour can be expressed using the coordinates of this colour when mapped in a standard colour space whose maxima and minima values are known—such as the so-called LUV space, YIQ space, and so on—it was possible to generate example colours by random selection of values for the different dimensions defining the colour space. Also, in cases where prototype colours were selected, it was sufficient to store the coordinates defining the position of the prototype colour in colour space.

Table 1 below contains a list of prototypes for English basic colour terms, expressed in terms of their coordinates in the LUV space (defined by the International Commission on Illumination, CIE). An advantage of using the CIE LUV colour space is that this is a colour space which is closer to being perceptually uniform than many other standard colour spaces.

TABLE 1

| Applicable | | | |
|---|---|---|---|
| colour | | | |
| term | L Coordinate | U coordinate | V coordinate |
| White | 96.001 | 5.0047 | −5.3132 |
| Black | 0.24299 | 0.034099 | −0.035908 |
| Red | 41.216 | 67.376 | 45.356 |
| Green | 41.216 | −52.061 | 11.916 |
| Yellow | 86.206 | −0.049755 | 98.617 |
| Blue | 51.576 | −0.41787 | −52.648 |
| Brown | 30.76 | 11.759 | 35.866 |
| Purple | 41.216 | 42.832 | −39.571 |
| Pink | 71.596 | 36.778 | −1.3779 |
| Orange | 61.697 | 45.3 | 65.853 |
| Grey | 56.664 | 3.2616 | −3.4561 |

The colour-term tutoring tool was configured to use, as its framework task during an interaction according to the first scenario (machine tutor produces language for comprehension by human user/student), a requirement for the user to interact with a GUI displaying the example colours making up the current context, notably a requirement for the user to click on the example colour which was described in the machine tutor's utterance (the utterance was presented on screen in association with display of the context).

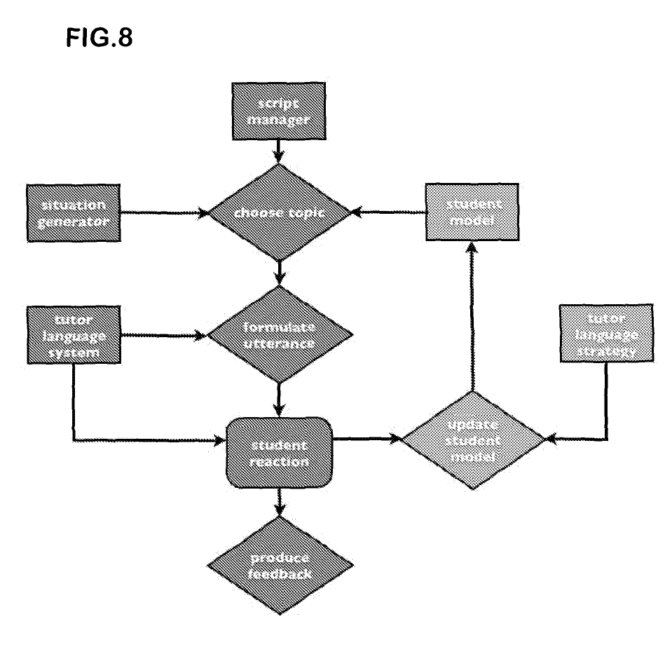

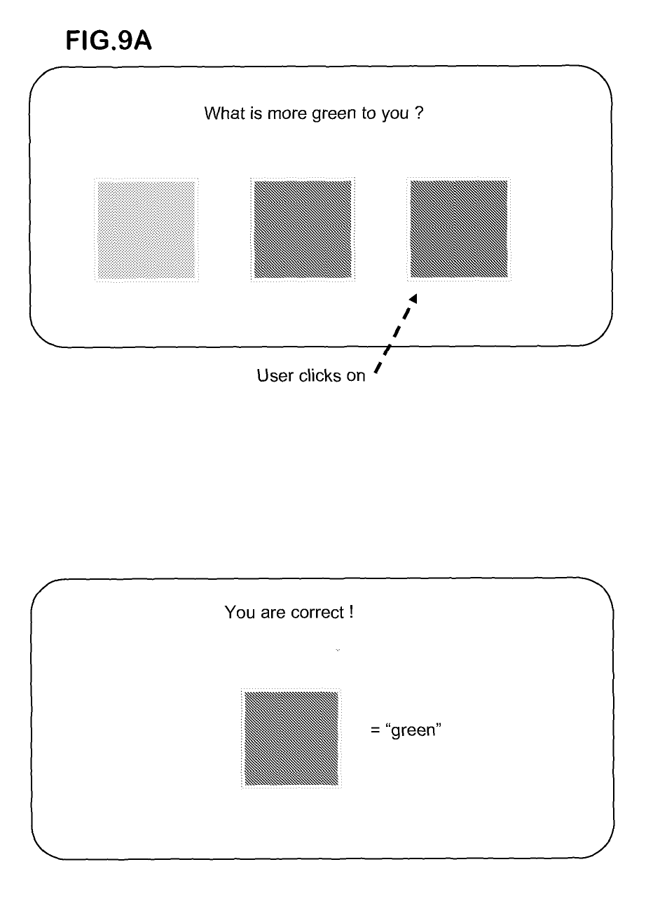

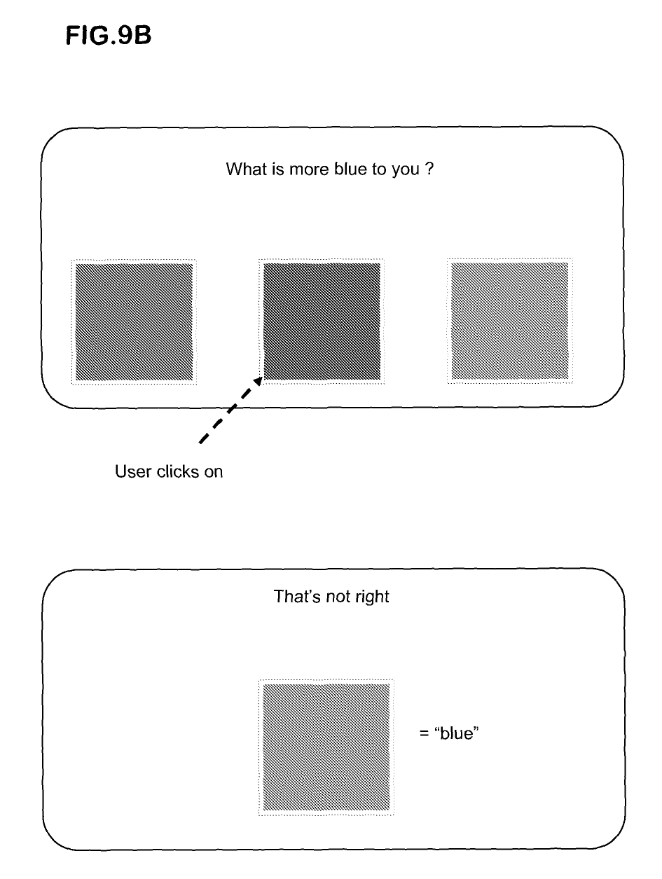

FIG. 8 is a diagram which illustrates, schematically, the main modules and processes that were used by the colour term tutoring module when implementing interactions according to the first scenario. Incidentally, in FIGS. 8, 10, 12, 15, 17 and 19, ovals are used to indicate inputs made via the machine-user interface. FIG. 9 illustrates screen views that were displayed during two example interactions according to the first scenario.

FIG. 9A illustrates screen views obtained in an interaction in which the user clicked on the correct colour—the top portion of FIG. 9A corresponds to a first screen view in which the user was presented with the context and the machine tutor's utterance, and the lower part of FIG. 9A corresponds to a subsequent screen view which notifies the user of the achievement of communicative success in this particular interaction. FIG. 9B illustrates screen views obtained in an interaction in which the user clicked on the wrong colour—the top portion of FIG. 9B corresponds, once again, to a first screen view in which the user was presented with the context and the machine tutor's utterance, and the lower part of FIG. 9B corresponds to a subsequent screen view which notifies the user of communicative failure and provides the user with correction data indicating the colour he should have identified.

In the case of communicative success in an interaction according to the first scenario, the tutoring tool updated its student model to ensure that the student model indicates the student's ability to comprehend the colour term in question. In the case of communicative failure, the tutoring tool maintained its student model in its existing state, or made an appropriate update, to ensure that the student model showed that the student does not comprehend the colour term in question.

The colour-term tutoring tool was configured to use, as its framework task during an interaction according to the second scenario (human user/student produces language for comprehension by machine tutor), a requirement for the user to produce language to describe an example colour forming part of the presented context, and for the machine tutor to correctly identify the intended example colour based on the language produced by the user. On-screen instructions were displayed to prompt the user to fulfil his part of the framework task.

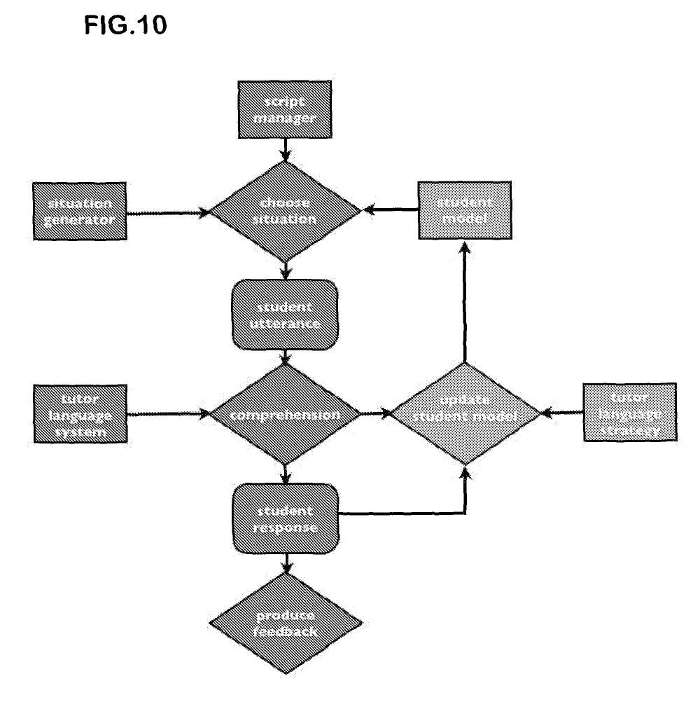

FIG. 10 is a diagram which illustrates, schematically, the main modules and processes that were used by the colour term tutoring module when implementing interactions according to the second scenario.

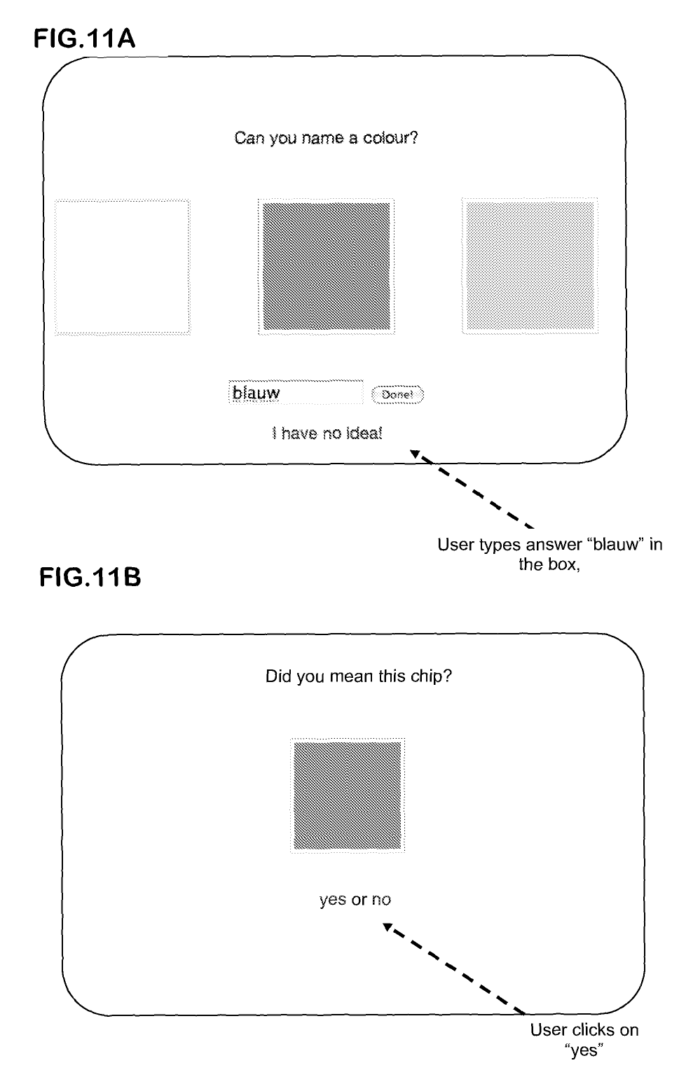

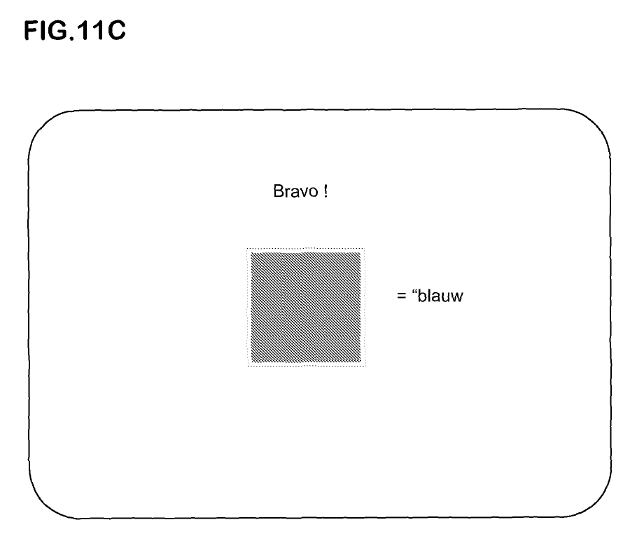

FIG. 11 illustrates screen views that were displayed during one example of a successful interaction according to the second scenario. FIG. 11 illustrates three screen views that appear, successively, during an interaction in which the user described an example colour present in the context using language that was correctly interpreted by the machine tutor. FIG. 11A corresponds to a first screen view in which the user was presented with the context and an on-screen instruction prompting him to enter a colour term describing an example colour of his choice in the context. FIG. 11B corresponds to a subsequent screen view in which the machine tutor displays the example colour which it considers to correspond to the colour term entered by the user. FIG. 11C corresponds to a subsequent screen view which notifies the user of the achievement of communicative success in this particular interaction and confirms the correct colour term for the example colour that the user selected.

In the case of communicative success in an interaction according to the second scenario, the tutoring tool updated its student model to ensure that the student model indicates the student's ability to apply the colour term in question correctly in language production. In the case of communicative failure, the tutoring tool maintained its student model in its existing state, or made an appropriate update, to ensure that the student model showed that the student is not able to apply this colour term correctly in language production.

The colour-term tutoring tool was configured to use, as its framework task during an interaction according to the fourth scenario (machine student, i.e. tutoring tool, producing language for comprehension by human tutor), a requirement for the human tutor to select an example colour in a context presented to him and a requirement for the machine to use the operational representation of its teacher model (in its current state) to produce language to describe the selected example. On-screen options were displayed enabling the user to indicate the correctness or incorrectness of the colour term employed by the machine, i.e. communicative success or failure. In the event that the tutoring tool's teacher model did not allow a colour term to be produced for the example colour selected by the user/tutor, an on-screen region was displayed in association with text to prompt the user/tutor to input a suitable colour term for integration into the teacher model.

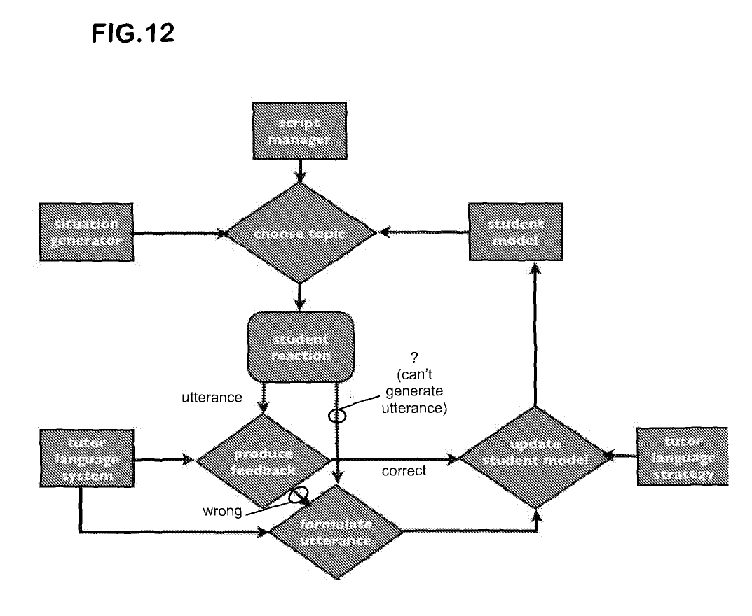

FIG. 12 is a diagram which illustrates, schematically, the main modules and processes that were used by the colour term tutoring module when implementing interactions according to the fourth scenario.

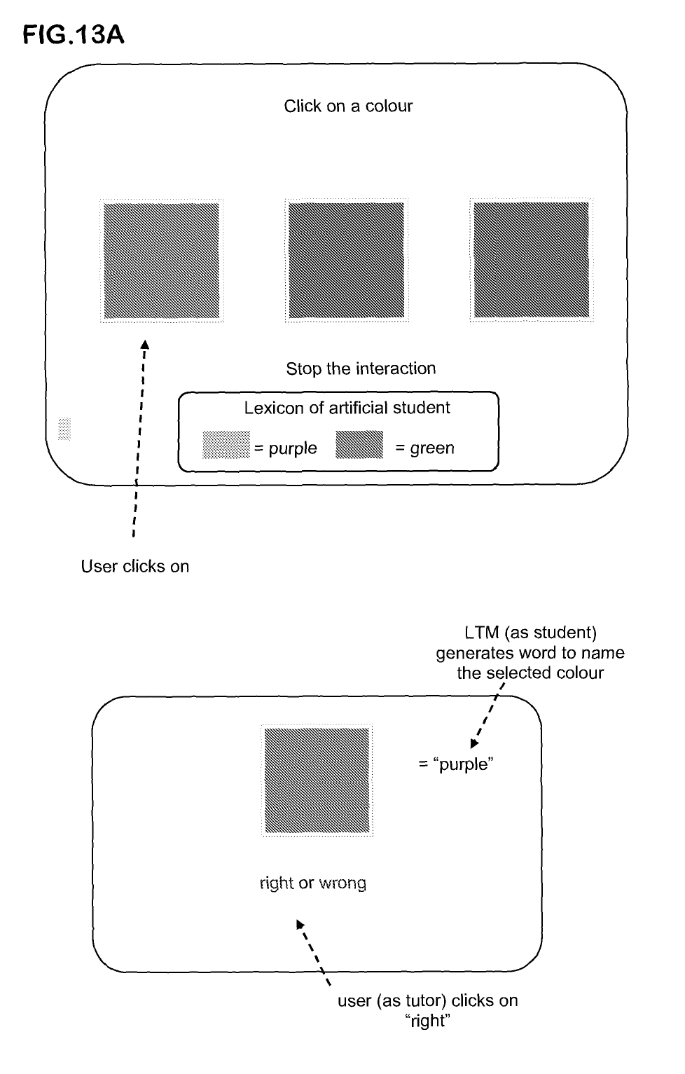

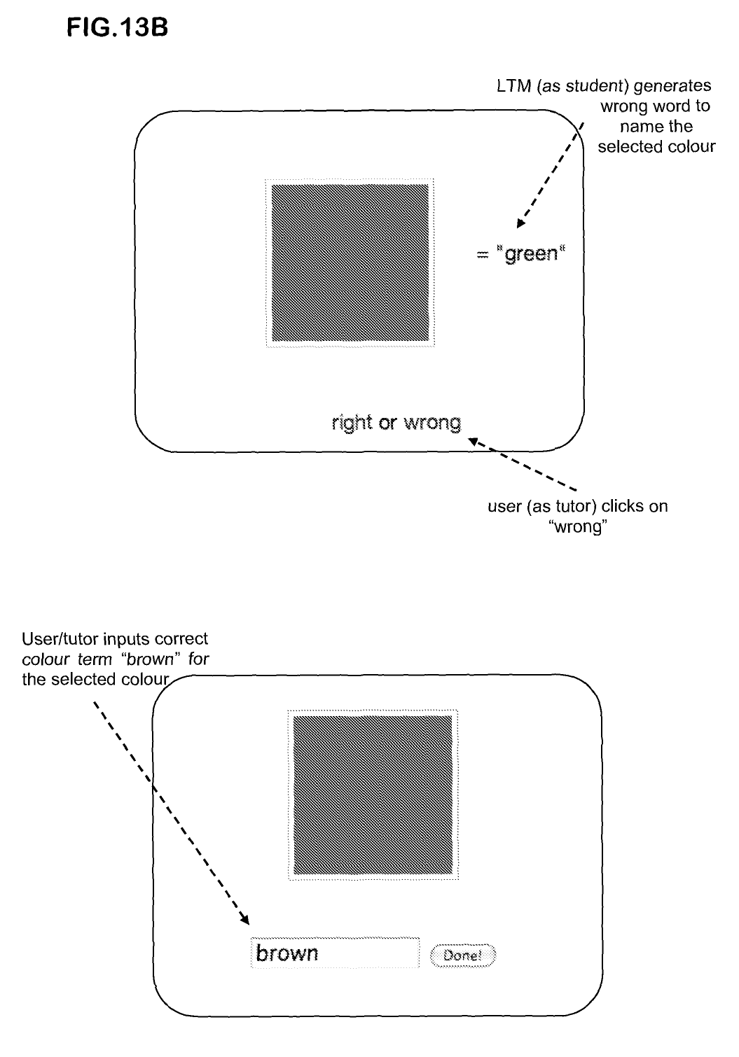

FIG. 13 illustrates screen views that were displayed during two example interactions according to the fourth scenario. FIG. 13A illustrates screen views that appear, successively, during a successful interaction. The top portion of FIG. 13A corresponds to a first screen view in which the user/tutor was presented with the context and an on-screen instruction prompted him to select one of the example colours in the context by clicking on its representation in a GUI. The bottom portion of FIG. 13A corresponds to a subsequent screen view in which the machine displays language intended to name the example colour selected by the user/tutor as well as on-screen elements (the words “right” and “wrong”) which enable the user/tutor to indicate whether or not communicative success has been achieved. In order to produce the colour term “purple” displayed in the bottom portion of FIG. 13A, the tutoring tool of the language tutoring system used its operational representation of the teacher model (in its current state of development) to produce language describing the user-selected example.

In the case of communicative success in an interaction according to the fourth scenario, the tutoring tool updated its teacher model to integrate the new example. This updating involves a process of generalizing the teacher model's prototype which defines the colour category expressed using the term “purple”, so as to accommodate the new example colour as a true example of “purple”. The learning strategy control's the generalization process.

FIG. 13B illustrates screen views that appear, successively, in the latter stages of an unsuccessful interaction according to the fourth scenario. The top portion of FIG. 13B corresponds to a screen view which represents the same stage in an interaction as the screen view displayed in the bottom part of FIG. 13A, in which the machine displays language (here “green”) intended to name a brownish example colour that has been selected by the user/tutor. In this case, the user/tutor clicks on the displayed word “wrong” so as to indicate that the machine/student has not selected an appropriate colour term. As a result, an additional screen display is generated, as illustrated in the bottom part of FIG. 13B, providing the user/tutor with an opportunity to input a new word (or a new example for existing words). In this case, the user inputs the word “brown” in a data-entry box provided in the GUI.

In the case of communicative failure in an interaction according to the fourth scenario, i.e. use of an incorrect colour term by the machine tutoring tool, the tutoring tool makes an appropriate update to the content of knowledge sources in the production section of the teacher model so as to register a new association between the user-input colour term and this example colour (and reduces the likelihood of using the incorrectly-produced colour term for this example colour in the future).

A description will now be given of some of the characteristics of the parsing and interpretation modules of the language-comprehension section of the operational representation of the language-system used in this example colour term tutoring tool. Likewise, a description will be given of the characteristics of the conceptualization and expression modules of its language-production section. Given that, in this tutoring tool, the architecture of the operational representation of the language-system is the same regardless of whether the teacher model or student model is being considered, a single description will be given that applies to implementation of the teacher model and to implementation of the student model.

In this example, the conceptualisation module in the language-production section was required to be able to generate a meaning to be expressed, i.e. a colour category, and the expression module was required to be able to translate the meaning into a message (“utterance”) in the target language, in this case the colour term expressing the colour category. IRL and FCG components were used to implement these functions.

In this example, the parsing module in the language-comprehension section was required to be able to input a message and reconstruct its meaning (e.g. to look up a colour term and retrieve an applicable colour category), and the interpretation module was required to apply the reconstructed meaning to the current situation, in this case to find the example colour in the context that was intended to be designated by the input message. Once again, FCG and IRL components were used to implement these functions.

In this example, the conceptualisation module was constituted using an IRL colour categorisation component which takes as its input the set of example colours (e.g. triples in LUV space) which constitute the context, with one example colour being the topic, and outputs a colour category that is distinctive for the topic in this context (i.e. a colour category that is applicable to the topic colour and which enables this topic colour to be differentiated from the other example colours in the context because this category does not apply to those other colours).

In this example, the IRL colour categorisation component made use of a knowledge source which defined a number of prototypes in colour space and each prototype defined a respective colour category having an associated name (colour term). Each prototype was represented by a point in colour space and, when seeking to determine which colour category applied to a given example colour, the categorisation component applied an operator which implemented a nearest neighbour computation to determine the prototype whose point in colour space was closest to the location of the example colour in colour space. An output was is given only if there was is a clear single category whose prototype was is closest to the topic but relatively far from the other example colours in the context.

In this example, the IRL interpretation module in the language-comprehension section was also constituted using a colour categorisation component but, in this case, the input was the set of example colours (e.g. triples in LUV space) which constitute the context, as well as a colour category. The output was an identification of the topic colour.

The colour categorisation component of the interpretation module also made use of a knowledge source which defined prototype colours in colour space. When seeking to determine what was the topic intended to be designated by the input colour category, the colour categorisation component of the interpretation module applied a nearest neighbour computation to find the example colour from the context that is closest, in colour space, to the prototype correspond to the input colour category. Once again, an output is given only if there is a single one of the example colours in the context which is close to the prototype for the input colour category.

The reader will have noticed that, in this example language-system, the conceptualisation and interpretation modules use the same formalism—a set of prototypes in colour space—to perform their allotted functions. New categories (prototypes) are defined, by both modules, in cases where no output could be given (i.e. no distinctive category was found). When the tutoring tool is engaged in interactions according to the third or fourth scenarios—i.e. the teacher model is being developed via interactions with a human tutor—a category is aligned, by both these modules, either by changing the LUV values of the prototype so as to reduce the distance, in colour space, between the prototype and the given topic, or by maintaining a record of the frequency of use of specific categories (and their success rate), and deleting a category from the inventory when its score becomes too low. In the specific implementation of this example, using IRL for conceptualization and interpretation, a single processing component acted as the conceptualization and interpretation module.

In a similar way, in this example tutoring tool the expression and parsing modules make use of the same formalism and can be implemented using functional units of the same type (or, even, by the same functional unit if FCG is used). In both cases a lexicon (e.g. a bi-directional associative memory) defines an association between colour categories and colour names. Expressing a colour category involves looking up in the lexicon the colour name which corresponds to a given colour category, and parsing a colour term involves looking up which colour category is associated with this colour term in the lexicon. In this example, every association in memory has an assigned score indicating the strength of this association, with stronger associations being used preferentially compared to weaker associations. This enables the expression and parsing modules to cope with synonymy (i.e. several words for the same meaning, but one preferred) and polysemy (several meanings for the same word but, again, with one preferred).

When the tutoring tool is engaged in interactions according to the third or fourth scenarios—i.e. the teacher model is being developed—the lexicon used by the expression and parsing modules can be improved, as follows:
if a word for a colour category is unknown then a new association is stored,
if a word was wrongly used for colour category then the score assigned to the association between this word and this colour category is decreased, and
if a word was used successful in relation to a colour category, then the score assigned to the association between this word and this colour category is increase and the scores assigned to competing associations is reduced (competing associations relate to synonyms or polysemous meanings).

In this example colour term tutoring tool, the teaching strategy which determined the situation that would be the context in a given interaction (and the colour terms used for expression and parsing) could vary a number of features of the situation/context and the employed colour terms, notably:
it could vary a number of determining factors relating to the colours in the context, notably:
   the number of example colours in the context,
   the minimum and maximum distance in the colour space, between the example colours in the context, and
   the distance, in colour space, between the sample colours and the prototype of the colour chip that is chosen as topic; and
it could vary the complexity of the employed colour terms, and notably:
   use only basic words,
   progressively use less frequent words, or
   use compound colour terms (e.g. “light brown”).

### Second Example Tutoring Tool

### Specialized Tense System

The linguistic sub-system being taught by the second example tutoring tool is a tense system that expresses the temporal structure of events (in terms of present/past/future) in the French language. Although there are languages other than French which include a linguistic sub-system relating to tense, few (or none) of these linguistic sub-systems use verb constructions that include auxiliaries in the same way as the tense language system in French. Accordingly, this tutoring tool is relatively specialized.

In this example also, the French-tense tutoring tool was configured in accordance with the above-described second embodiment of the invention, so as to use a learning component to implement the operational representation of the teacher model and student model, notably a learning component using IRL and FOG. Accordingly, interactions between the tutoring tool and a user according to any of the above-described first to fourth scenarios were supported.

A language tutoring machine including this French-tense tutoring tool was implemented using, as before, a general purpose computer apparatus having an operational Common LISP system and loaded with Babel2 (whereby it includes modules for Fluid Construction Grammar and Incremental Recruitment Language, as well as a meta-level architecture and web interface, all as described above) but this time configured according to the program listing annexed hereto as Annex B.

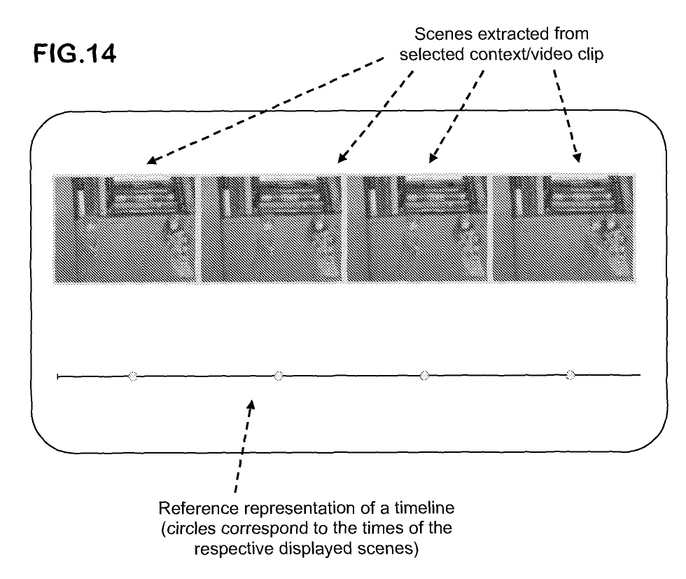

The French-tense tutoring tool made use of a learning strategy in which each of the possible situations (or contexts) that the tutoring tool could select as the object of communication between the tutoring tool and the user corresponded to a video clip. Each of the video clips had been edited (cut) into different scenes and, when a selected context was presented to the user this entailed simultaneous display to the user of the various scenes of the video clip arranged, in relation to a displayed timeline, in the same time order as the scenes appeared in the video clip. FIG. 14 provides an example of a screen display which presents a selected context (video clip) to the user in this way.

In this application, explicit data was stored defining each possible context (i.e. each video clip) and presentation of the context to the user involved rendering data from the selected video clip, on a display screen visible to the user.

The French-tense tutoring tool was configured to use, as its framework task during an interaction according to the first scenario (machine tutor produces language for comprehension by human user/student), a requirement for the user to interact with a GUI displaying the scenes making up the current context (video clip), notably a requirement for the user to identify the scene which is described in the machine tutor's utterance (the utterance being presented on screen in association with display of the context).

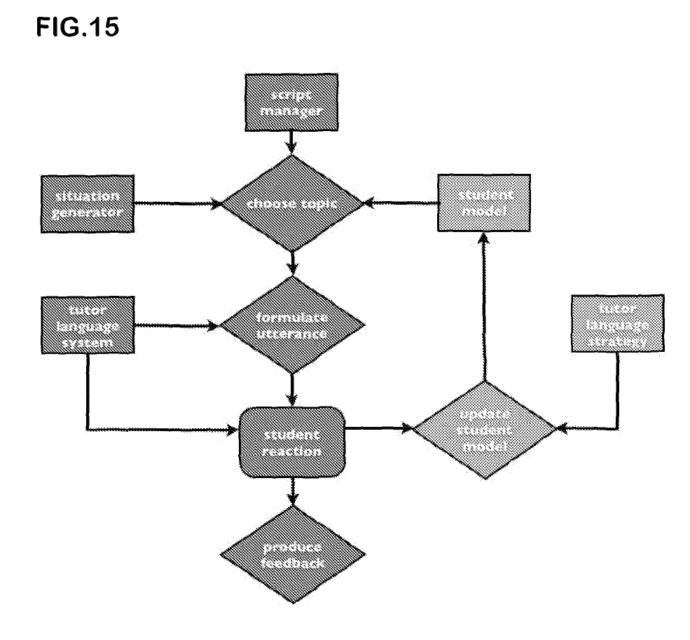

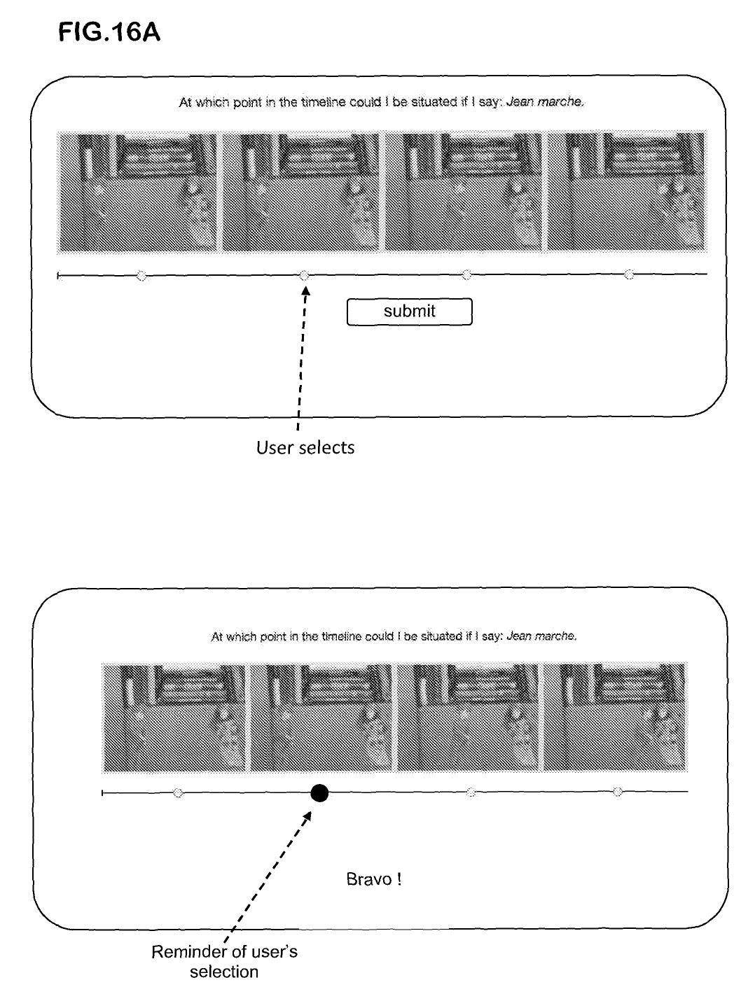

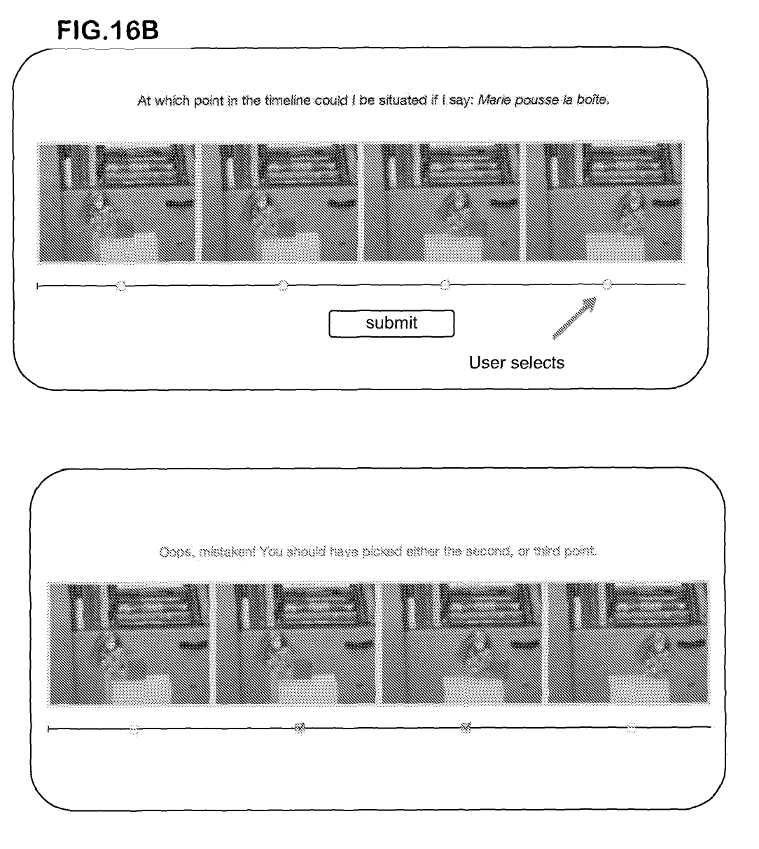

FIG. 15 is a diagram which illustrates, schematically, the main modules and processes that were used by the French-tense tutoring tool when implementing interactions according to the first scenario. FIG. 16 illustrates screen views that were displayed during two example interactions according to the first scenario.

FIG. 16A illustrates screen views obtained in an interaction in which the user selected the correct point on the reference timeline—the top portion of FIG. 16A corresponds to a first screen view in which the user was presented with the context and the machine tutor's utterance, and the lower part of FIG. 16A corresponds to a subsequent screen view which notifies the user of the achievement of communicative success in this particular interaction. FIG. 16B illustrates screen views obtained in an interaction in which the user selected the wrong point on the reference timeline—the top portion of FIG. 16B corresponds, once again, to a first screen view in which the user was presented with the context and the machine tutor's utterance, and the lower part of FIG. 16B corresponds to a subsequent screen view which notifies the user of communicative failure and provides the user with correction data indicating the point on the reference timeline that he should have selected.

In the case of communicative success in an interaction according to the first scenario, the tutoring tool updated its student model to ensure that the student model indicates the student's ability to comprehend the aspect of the French tense system that was demonstrated in the interaction. In the case of communicative failure, the tutoring tool maintained its student model in its existing state, or made an appropriate update, to ensure that the student model showed that the student does not comprehend this aspect of the French tense system.

The French tense tutoring tool was configured to use, as its framework task during an interaction according to the second scenario (human user/student produces language for comprehension by machine tutor), a requirement for the user to produce language to describe a specified scene forming part of the presented context, and for the machine tutor to correctly determine whether or not this description does, indeed, apply to the specified scene. On-screen instructions were displayed to prompt the user to fulfil his part of the framework task.

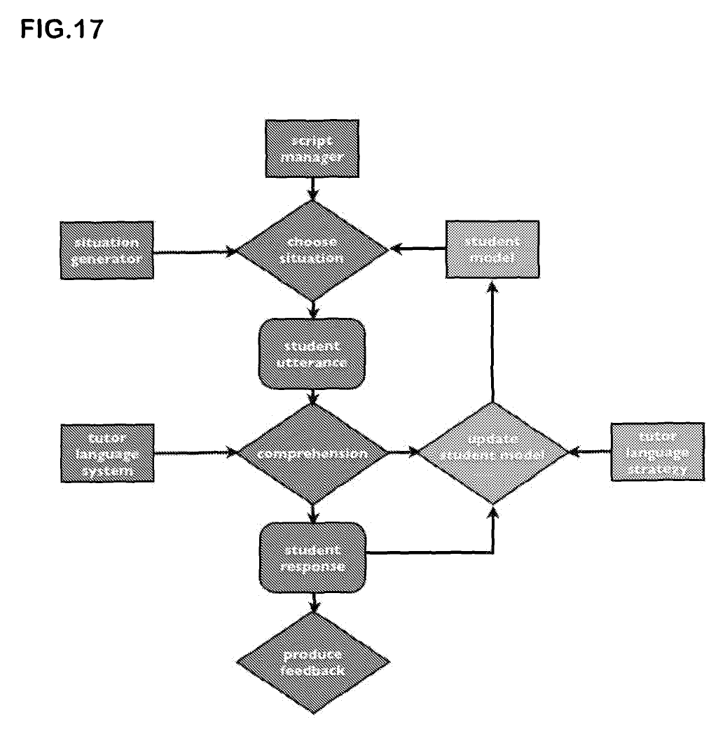

FIG. 17 is a diagram which illustrates, schematically, the main modules and processes that were used by the French tense tutoring tool when implementing interactions according to the second scenario.

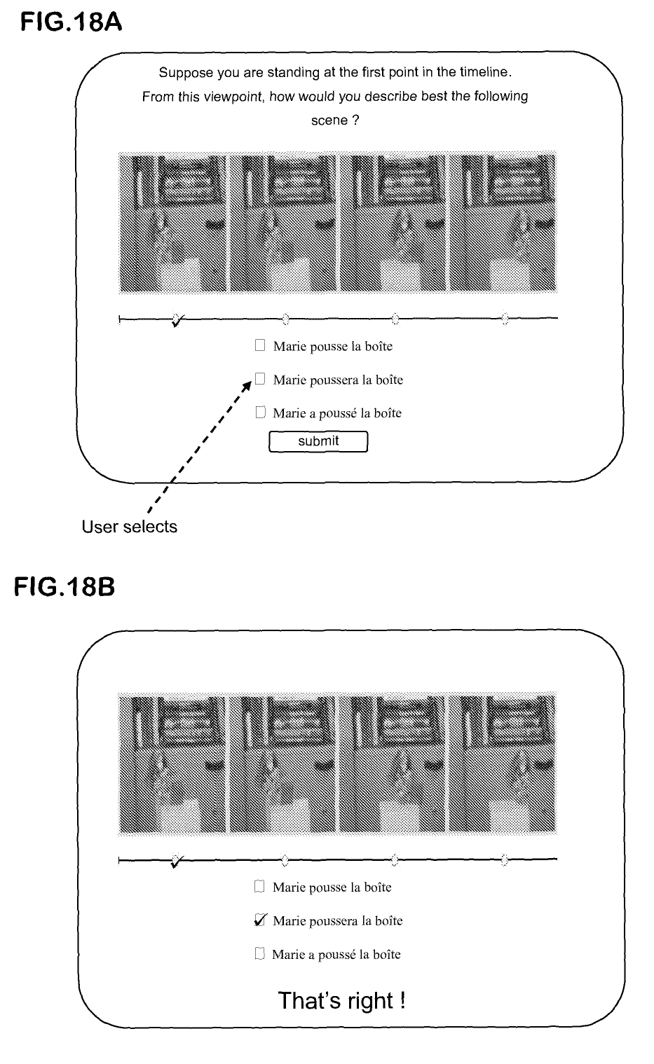

FIG. 18 illustrates screen views that were displayed during one example of a successful interaction according to the second scenario, FIG. 18 illustrates two screen views that appear, successively, during an interaction in which the user selected one of three proposed statements to describe a specified scene present in the context and the machine tutor correctly determined that the selected statement did describe the specified scene in the context (selected video clip). FIG. 18A corresponds to a first screen view in which the user was presented with the context and an on-screen instruction prompting him to select one of the proposed statements which described a specified topic in the context. FIG. 18B corresponds to a subsequent screen view which notifies the user of the achievement of communicative success in this particular interaction. Because all the descriptive statements proposed to the user involve use of the French tense language system, communicative success tends to demonstrate that the user is competent at producing language involving the aspect of the French tense system that is challenged in this interaction.

In the case of communicative success in an interaction according to the second scenario, the tutoring tool updated its student model to ensure that the student model indicates the student's ability to correctly apply the relevant aspect of the French tense language-system in language production. In the case of communicative failure, the tutoring tool maintained its student model in its existing state, or made an appropriate update, to ensure that the student model showed that the student is not able to apply this aspect of the French tense language-system in language production.

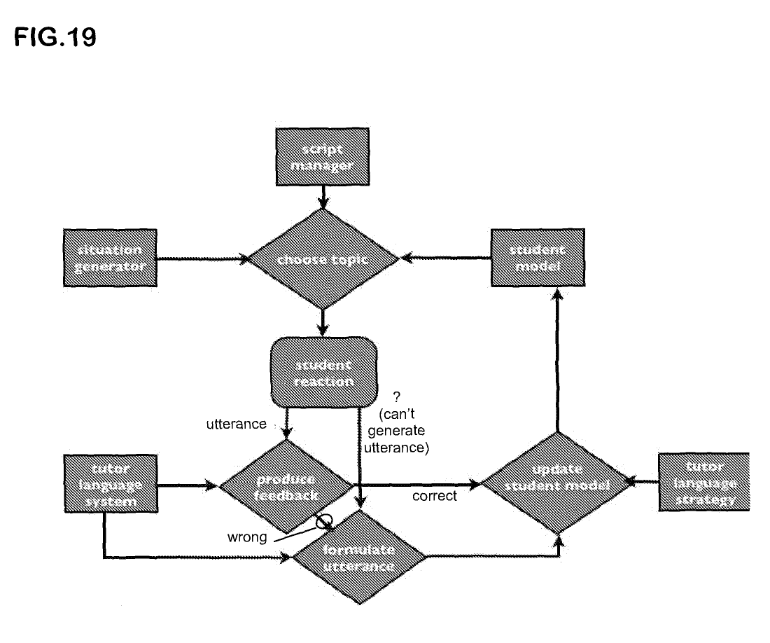

FIG. 19 is a diagram which illustrates, schematically, the main modules and processes that were used by the French tense tutoring tool when implementing interactions according to the fourth scenario.

A description will now be given of some of the characteristics of the parsing and interpretation modules of the language-comprehension section of the operational representation of the language-system used in this example French tense tutoring tool. Likewise, a description will be given of the characteristics of the conceptualization and expression modules of its language-production section of the operational representation of the language-system. Given that, in this tutoring tool, the architecture of the operational representation of the language-system is the same regardless of whether the teacher model or student model is being considered, a single description will be given that applies to implementation of the teacher model and to implementation of the student model.

In this example, the conceptualisation module in the language-production section was required to be able to generate a meaning to be expressed, in this case a way to categorise the moment when an event takes place in relation to another event (typically the moment of speaking)—for example a meaning that can be designated “present tense” signifies that the time of speaking and the event coincide. The expression module in the language-production section was required to be able to translate the meaning into a message in the target language; typically the tense category is translated into auxiliaries and morphological markings of the verb. IRL and FCG components were used to implement these functions.

In this example, the parsing module in the language-comprehension section was required to be able to input a message and reconstruct its meaning (e.g. to parse the message and retrieve the tense category (as well as the rest of the semantic structure which is scaffolded in this case). The interpretation module was required to apply the reconstructed meaning to the current situation, in this case to find the events which best fit with the tense category in the current scene. Once again, FCG and IRL components were used to implement these functions.

In this example, the IRL conceptualisation module was constituted using a temporal categorisation component which takes as its input the set of scenes which constitute the context (i.e. which make up the video clip), with one scene being the topic, and outputs a tense category (e.g. past/present/future) that is distinctive for the topic in this context.

In this example, the temporal categorisation component made use of a knowledge source which defined predicates (e.g. push, walk) which can describe events and which are valid for an interval of time. Tense categories delineate intervals from a perspective on the scene (typically another event, or a time of speaking).

In this example, the IRL interpretation module in the language-comprehension section was also constituted using a temporal categorisation component but, in this case, the input was the set of scenes which constitute the context, as well as a tense category. The output was an identification of the topic scene that fits with the tense category (and there could be more than one scene which fits).

The temporal categorisation component of the conceptualisation module and that of the interpretation module use the same formalism to perform their respective tasks (and, in practice, the same IRL component was used to constitute both the conceptualization and the interpretation modules). This particular formalism is inspired by standard formalisms in artificial intelligence (such as Allen's temporal logic). This formalism associates to each event a given time period (a moment or interval during which some predicate applied), as well as a “meets” operation which evaluates how periods “meet” each other in time (i.e. the way in which they overlap). The needed tense categories are then defined based on these time periods and application of the “meets” operation. The tense categories that were defined in this example French tense tutoring tool were;

In(i,j)—period i is contained in period j;

Disjoint(i,j)—periods i and j do not overlap in any way;

Starts(i,j)—period i is an initial sub-segment of period j;

Finishes(i,j)—period i is a final sub-segment of period j;

SameEnd(i,j)—periods i and j end at the same time; and

Overlaps(i,j)—period i starts before but overlaps period j.

The IRL temporal categorisation component(s) formed new temporal categories by the combination of operations and predicates over time periods of events (e.g. overlap, before, after, etc.). Each temporal category was assigned a score which indicated its success in conceptualisation/interpretation. This score assigned to a given temporal category was updated in dependence on whether or not communicative success was achieved in interactions which involved this temporal category. Temporal categories with low scores were eliminated from the inventory.

In a similar way, in this example tutoring tool the expression and parsing modules make use of the same formalism and can be implemented using functional units of the same type. In both cases a grammar was used, as well as a lexicon (the lexicon being capable of implementation using a bi-directional associative memory, as in the colour term tutoring tool). According to this shared formalism, most aspects of a statement (e.g. the different participants in an event, or the definition of the verb itself) are scaffolded, and there are rules for:
mapping a semantic description of events into a tense category, and
mapping a tense category into its surface forms.
   Moreover, the learning strategy employed in the example French tense tutoring tool was designed to enable the student to form associations between a tense category and a corresponding surface form.

In order to achieve bi-directionality (i.e. in order for the same formalism to be useable both by the expression module and by the parsing module) this embodiment of the invention made use of Fluid Construction Grammar. As recalled above, FCG makes it possible to write down linguistic rules and to apply them in parsing or expression. FIGS. 20 and 21 give a flavour of how these rules look: FIG. 20 expresses a syntactic rule for expressing the passé composé French tense and FIG. 21 expresses a semantic rule for establishing the passé composé tense, as described above.

The skilled person will readily understand how he can use FCG to create rules that are adapted to the particular linguistic construction he wishes his tutoring machine to teach, and adapted to the particular resources (media clips, etc.) he has available for defining the context and subject of communications between the tutoring machine and a user. However, a couple of illustrative examples are given below:

### Illustrative Example 1

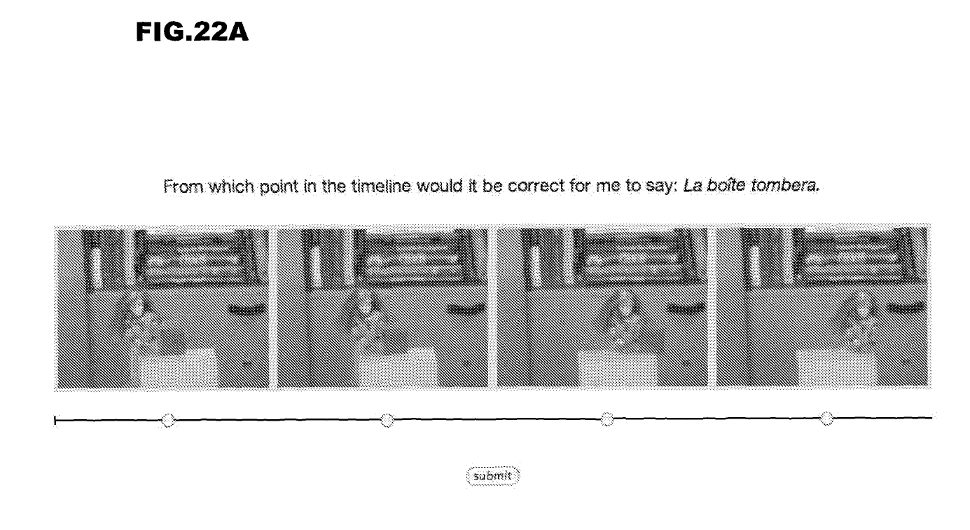

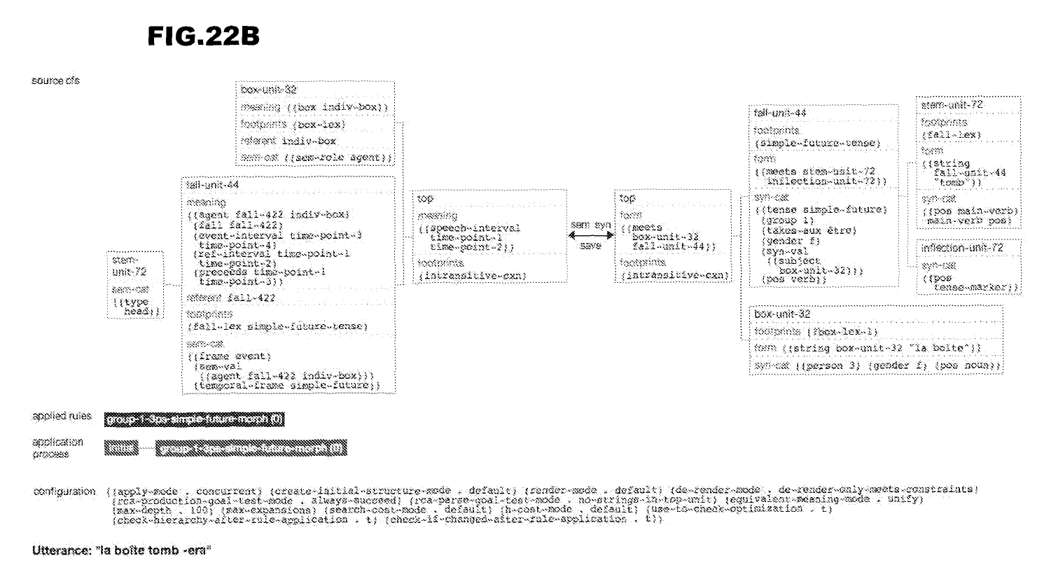

### FIG. 22 illustrates one example of certain characteristics of the above-described French-tense tutoring tool when it is configured to teach the future tense. FIG. 22A illustrates a screen view that may be generated for display at the start of an interaction according to the first scenario, in which the user/student must try to understand what is meant by the expression “La boîte tombera”. It will be noted that this interaction re-uses the video clip frames that were used in the interaction illustrated in FIG. 16B—in other words, the same context can be used as the basis for interactions designed to teach different elements of linguistic knowledge.

FIG. 22B illustrates a part of the task of expressing the meaning of the utterance “La boîte tombera” using FCG, for the interaction illustrated in FIG. 22A:
the top portion of FIG. 22B shows one configuration of an FCG transient coupled-feature structure that the French-tense tutoring tool's expression module developed (using FCG) during the process of expressing the utterance “La boîte tombera”, and the represented configuration shows the transient coupled-feature structure before application of a particular rule/construction (hence this configuration is designated “source cfs”),
the “applied rules” line just below gives the name of an FCG rule (“group-1-3ps-simple-future-morph (0)”) that was applied to the illustrated source coupled feature-structure during the expression process,
the “application process” line illustrates the search tree during this part of the expression process—in this case there is only one search node but typically, in more complex examples, the search tree branches into several hypotheses—this search tree begins with an initialization process,
the “configuration” line illustrates various FCG parameters that can be set (for example by the designer) in order to control and manipulate how the linguistic processing performed by the FCG processing engine (for example, it may contains “goal-tests” that FCG can perform to check whether or not it should stop a processing task).

### Illustrative Example 2

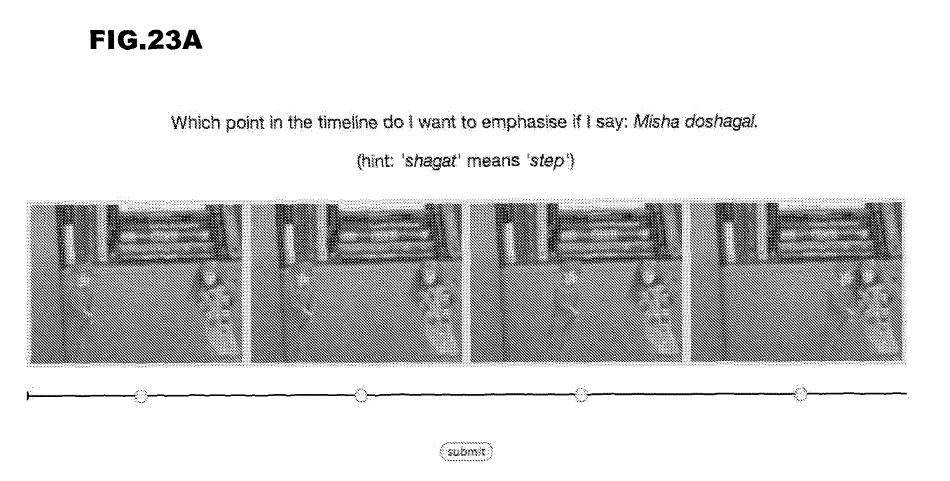

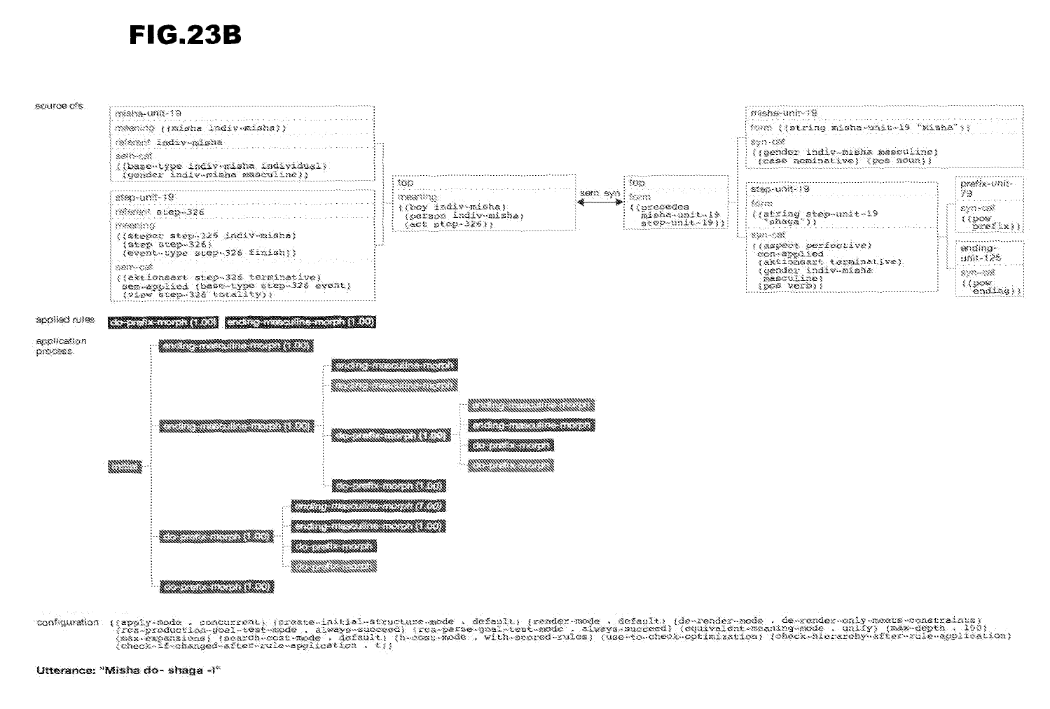

### FIG. 23A illustrates one example of possible attributes of a tutoring machine according to the invention configured to teach the aspect system used in Russian. FIG. 23A illustrates a screen view that may be displayed at the start of an interaction according to the first scenario (human user as student) in which the user/student must try to understand what is meant by the expression “Misha doshagal”. It will be noted that this interaction re-uses the video clip frames that were used in the interaction illustrated in FIGS. 14 and 16A.

FIG. 23B illustrates part of the processing involved in expressing, using FCG, the meaning of the utterance “Misha doshagal” used in the interaction illustrated in FIG. 23A.
the top portion of FIG. 23B illustrates one configuration of a transient coupled-feature structure that the Russian-aspect tutoring tool's expression module developed (using FCG) during expression of the utterance “Misha doshagal”,
the “applied rules” line just below gives the name of two FCG rules (“do-prefix-morph (1.00)” and “endings-masculine-morph (1.00)”) that were applied by the FCG component to the above-mentioned FCG feature structure in order to develop it further (in pursuance of the expression process),
the “application process” line displays the somewhat more complex search tree that applied in this case (where multiple hypotheses had to be considered),
the “configuration” line lists the FCG settings operative for the FCG component when applying the listed constructions to the coupled-feature structure represented at the top of FIG. 22B.

A third embodiment of the invention will now be described.

As mentioned above, the language tutoring machines and methods according to the present invention present a language leaner with a challenge during the communicative interactions between the language learner and the language tutoring machine: can the student comprehend an utterance produced by the machine, in a given context, so that a framework task can be successfully completed or produce a suitable utterance, in context. Different factors affect how easy or difficult the user/student will find it to achieve communicative success when playing his part in the framework task.

For example, the student will generally find it easier to achieve communicative success in cases where he is learning categories that are broadly defined compared to cases where the categories are narrowly defined. For instance, in the above-described example of an embodiment tutoring tool designed to teach colour terms to a student, the student may find it relatively easy to correctly appreciate distinctions between primary colours (such as blue, red and green) whereas he may find it considerably more difficult to grasp the distinctions between shades of the same colour (e.g. the different shades of blue that are designated “turquoise”, “sky-blue” and “aquamarine” in English).

In the third embodiment of the invention, parameters are defined which quantify the level of difficulty that a student is liable to experience when taking part in a particular type of communicative interaction with a language tutoring tool in a particular context. In the third embodiment, the control unit of the tutoring tool, which implements the teaching strategy, may be configured to control the interactions between the tutoring tool and the user so that particular interactions have a particular level of difficulty (as quantified by the parameters applicable to this tutoring tool). Thus, taking the same colour-teaching example as before, the control unit managing the colour-teaching tutoring tool could control the difficulty level of particular interactions with a user based on a parameter which measures the similarity or difference between colour samples which are presented to the user in that interaction. It is relatively simple to define appropriate parameters for quantifying the difficulty level in this case: for example, one possible parameter would be the reciprocal of the distance, in colour space (e.g. LUV space), between the colour samples involved in the communicative interaction.

By designing the third embodiment of the language tutoring system so that the level of challenge presented to the user during his learning of a language is made explicitly controllable, it becomes possible to attempt to match the difficulty level of an interaction to the user's current level of proficiency in relation to the language-system being taught (the current level of proficiency being indicated by the student model). This matching of difficulty-level to skill is advantageous for the following reason.

Research work by Csikszentmihalyi and Selega has shown that when a person engaged in an activity feels that the level of challenge presented by this activity is matched to their skill level, they experience a sense of well-being and accomplishment (which has been designated “the flow state”). A mismatch between these factors leads either to boredom (if the challenge level is much lower than the skill level) or anxiety (if the challenge level is much greater than the skill level). A language student will not be motivated to learn if he experiences boredom or anxiety when using a language tutoring system. Accordingly, the student's motivation should be maximized in the third embodiment of language tutoring system according to the invention which matches the difficulty level of an interaction to the user's current level of proficiency in relation to the language-system being taught.

In the third embodiment of language tutoring system, the difficulty level inherent in a given interaction between the user and a tutoring tool is quantified (“parametrized”) in terms of one or more parameters which are meaningful in relation to the language-system in question. The control unit of this tutoring tool then controls factors which affect the difficulty level of the interactions, so as to match the challenge level to the user's competence. The control unit may be configured to implement this matching procedure automatically. Advantageously, the language tutoring system according to the third embodiment may be configured so as to enable the user to indicate what level of challenge he wishes to experience at a given time, or to allow the user to indicate that he wishes to turn on or turn off the automatic-matching procedure.

Incidentally, according to the third embodiment various approaches can be used to assess the user's skill level so that the difficulty level of the interactions can be set accordingly. One simple approach consists in monitoring the rate of communicative success that is currently being achieved in interactions between the user and the tutoring tool: a low level of communicative success tends to indicate that the challenge level is too high.

Features of the first to third embodiments of the invention described above may be combined in various combinations, as desired, even if not explicitly stated above, unless a particular combination is precluded by some inherent technical incompatibilty between the features in question.

The reader will readily understand that the present invention provides language tutoring methods that comprise method steps which correspond to the functions that are implemented in the various embodiments of language tutoring machine described above (and in embodiments combining features thereof as evoked in the preceding paragraph). Certain specific method steps are indicated in the flow diagrams of FIGS. 3 to 7, and in the above description relating to particular scenarios which can apply to communicative interactions between the language tutoring machines according to the invention and a user.

As mentioned above, the language tutoring machines according to the invention will often be created by appropriate programming of computing apparatus. The reader will readily understand that the present invention provides computer programs that correspond to this programming. The computing apparatus may access the relevant computer programs in substantially any form: for example, a relevant computer program may be recorded on a storage medium (tape, disc, etc.), loaded onto the hard disk of a computer apparatus, put in communication with the computer apparatus over a network connection from a remote location, and so on.

Although the present invention has been described above with reference to particular embodiments thereof, the skilled person will readily understand that the present invention is not limited by the details of the above-described embodiments. More particularly, the skilled person will understand that various modifications and developments can be made in the above-described embodiments and that different embodiments can be designed without departing from the present invention as defined in the appended claims.

For example, the examples given above relate to tutoring tools configured to teach proficiency in a linguistic system which is a lexical system of colour terms which express perceptually-grounded colour categories, and in a linguistic system which deals with spatio-temporal language (notably a tense system that expresses the temporal structure of events), the language tutoring machines and methods according to the invention can provide tutoring tools relating to a wide variety of linguistic systems including, but not limited to:
a grammatical system expressing the abstract role of participants in an event (agent, patient, instrument, beneficiary, etc.) through word order or prepositions (as in “Joachim gives a book to Vanessa” versus “Vanessa gives a book to Joachim”), or with cases (as in German “die Frau gibt ihrem Mann diesen Buch”), or other means.
a lexico-grammatical system for expressing spatial relations, such as using preposition “next to” in the phrase “the block next to me”.
a lexical system of posture distinctions and bodily action words, useful for commanding or describing body postures, such as “stand”, “sit” and “lie”.
a system of determiners for being more precise about the possible referents of a noun phrase, for example, through articles, demonstratives, or quantifiers, as in “the book” (definite) versus “a book” (indefinite).
a system for structuring subordinate clauses, in which sentences appear as recursive parts of other sentences, such as in relative clauses like “the first girl who saw a bird got a present”.
action language.
a grammatical system for marking topic/comment structure (what is foreground/what is background), for example through different sentence patterns (as the field topology in German) or special particles (as “a” in Japanese).

1. A language tutoring machine configured to engage in communicative interactions with a user for teaching of a linguistic sub-system of a specified language, the language tutoring machine comprising:
a user interface for presenting a user with outputs and receiving user inputs, said user interface being configured to support said communicative interactions between the language tutoring machine and the user;
a first operational representation of said linguistic sub-system, wherein said first operational representation corresponds to a target language-system operable for producing language or for comprehending language in conformity with said linguistic sub-system;
a second operational representation of said linguistic sub-system, wherein said second operational representation corresponds to a student language-system operable for producing language or for comprehending language, wherein said student language-system models the performance of a specified user; and
a control unit configured to control at least the context applicable to the communicative interactions between the language tutoring machine and a user, to determine whether communication was successful in a communicative interaction with the user, and to update at least one of said first and second operational representations based on the result of the determination;
wherein:
the data structures and procedures used in the student language-system, for representing the knowledge sources the student language-system employs for language production and language comprehension, are the same as the data structures and procedures used in the target language-system, for representing the knowledge sources the target language-system employs for language production and language comprehension.

2. A language tutoring machine according to claim 1, comprising a learning component configured to develop said first operational representation of the target language-system by engaging in communicative interactions with a user.

3. A language tutoring machine according to claim 2, wherein said learning component is configured to develop both the first operational representation of the target language-system and the second operational representation of the student language-system.

4. A language tutoring machine according to claim 1, 2 or 3, wherein the operational representations of the target language-system and the student language-system comprise an Incremental Recruitment Language module configured to input meanings to be conveyed in respective communicative interactions between the language tutoring machine and a user, to convert input meanings into respective constraint networks encoding the semantic structure of the respective input meaning, to input constraint networks representing respective semantic structures, and to convert input constraint networks into respective meanings corresponding to the semantic structure encoded in the respective input constraint network.

5. A language tutoring machine according to any one of claims 1 to 4, wherein the operational representations of the target language-system and the student language-system comprise a Fluid Construction Grammar module configured to express input meanings as utterances and to parse input utterances into meanings.

6. A language tutoring machine according to claim 5, wherein said learning component comprises a Incremental Recruitment Language module and a Fluid Construction Grammar module.

7. A language tutoring machine according to any previous claim, wherein the initial configuration of the second operational representation of the student language-system, applicable for a specified student, embodies data structures and/or procedures that are used in the native language of said specified student.

8. A language tutoring machine according to any previous claim, wherein the control unit comprises a module storing rules defining plural teaching strategies, and is configured to make a selection from among said plural teaching strategies and, dependent on the selected teaching strategy, to control at least one parameter in the list comprising: the context applicable to the communicative interactions between the language tutoring machine and a user, the chosen pattern of interaction applicable to the communicative interactions between the language tutoring machine and a user, the conceptualization applied within a particular context when producing and understanding an utterance, and the complexity of the conceptualization and corresponding grammar applied when producing and understanding an utterance.

9. A language tutoring machine according to claim 8, wherein the control unit comprises a matching unit configured to assess the level of linguistic challenge presented to a user during communicative interactions and to control parameters of the situation selected as the context for a communicative interaction with the user so as to match the assessed level of linguistic challenge for said communicative interaction having said situation as context with a level of challenge specified by the control unit or the user.

10. A computer program having a set of instructions which, when in use on computer apparatus, cause the computer apparatus to perform the steps of:
engaging in communicative interactions with a user, via a user interface, for teaching of a linguistic sub-system of a specified language;
providing a first operational representation of said linguistic sub-system, wherein said first operational representation corresponds to a target language-system operable for producing language or for comprehending language in conformity with said linguistic sub-system;
providing a second operational representation of said linguistic sub-system, wherein said second operational representation corresponds to a student language-system operable for producing language or for comprehending language, wherein said student language-system models the performance of a specified user; and
controlling at least the context applicable to the communicative interactions with the user;
determining whether communication was successful in a communicative interaction with the user; and
updating at least one of said first and second operational representations based on the result of the determination made in the determining step;
wherein the data structures and procedures used in the student language-system, for representing the knowledge sources the student language-system employs for language production and language comprehension, are the same as the data structures and procedures used in the target language-system, for representing the knowledge sources the target language-system employs for language production and language comprehension.
